(19) United States
(12) Patent Application Publication
(10) Pub. No.: US 2015/0169228 A1
(43) Pub. Date: Jun. 18, 2015

(54) SYSTEM AND METHOD OF STORING DATA AT A NON-VOLATILE MEMORY

(71) Applicant: Sandisk Technologies Inc., Plano, TX (US)

(72) Inventors: VIJAY SIVASANKARAN, BANGALORE (IN); ABHIJEET MANOHAR, BANGALORE (IN); RAJEEV NAGABHIRAVA, SANTA CLARA, CA (US); KIRAN KUMAR MURALIDHARAN, BANGALORE (IN)

(73) Assignee: Sandisk Technologies Inc., Plano, TX (US)

(21) Appl. No.: 14/177,038

(22) Filed: Feb. 10, 2014

(30) Foreign Application Priority Data
Dec. 12, 2013 (IN) 5726/CHE/2013

(51) Int. Cl. G06F 3/06

(52) U.S. Cl. CPC G06F 3/0608; G06F 3/0679; G06F 3/0644; G06F 2206/1014

(57) ABSTRACT

A data storage device includes a controller coupled to a non-volatile memory that includes a plurality of dies. The plurality of dies includes a first die and a second die. The controller is configured to receive data to be stored into the non-volatile memory and to partition the data into a first portion and a second portion. The controller is further configured to store the first portion into the first die and to store the second portion into the second die. The first portion is stored into the first die using a single-bit mode. The second portion is stored into the second die using a multi-bit mode.

### CROSS-REFERENCE TO RELATED APPLICATIONS

The present application claims priority from Indian Application No. 5726/CHE/2013, filed Dec. 12, 2013, the contents of which are incorporated by reference herein in their entirety.

### FIELD OF THE DISCLOSURE

The present disclosure is generally related to storing data at a non-volatile memory.

### BACKGROUND

Non-volatile data storage devices, such as embedded memory devices (e.g., embedded MultiMedia Card (eMMC) devices) and removable memory devices (e.g., removable universal serial bus (USB) flash memory devices and other removable storage cards), have allowed for increased portability of data and software applications. Users of non-volatile data storage devices increasingly rely on the non-volatile storage devices to store and provide rapid access to a large amount of data. For example, a user may store large audio files, images, videos, and other files at a data storage device.

A data storage device including a non-volatile memory having a plurality of dies may be designed to achieve a product performance requirement (e.g., a data storage rate and/or a total storage capacity). Each die of the plurality of dies may be associated with a corresponding storage capacity. To achieve a particular data storage rate, data stored into the non-volatile memory may be interleaved. The data may be stored into the non-volatile memory by concurrently programming the data into a number of dies (N) of the plurality of dies. Using interleaving, an achievable data storage rate of the data storage device may be determined by the number of dies (N) multiplied by a performance per die (P). Typically, the data storage device is designed such that the plurality of dies includes Multi-Level Cell (MLC) dies. However, if the achievable data storage rate (N*P) using the MLC dies would not meet the product performance, such as the data storage rate, the data storage device may be designed using Single-Level Cell (SLC) dies. When SLC dies are used to achieve the data storage rate, the total storage capacity of the product performance requirement may be satisfied by using twice as many SLC dies as would be included in the data storage device than if MLC dies were used. Having to use twice the number of dies (e.g., a number of SLC dies as compared to a number of MLC dies) to satisfy a data storage rate requirement results in additional monetary costs when designing and producing the data storage device and results in additional power consumption when operating the data storage device.

### SUMMARY

Techniques are disclosed for programming dies of a non-volatile memory included in a data storage device using a mixed mode programming scheme. The mixed mode programming scheme may include concurrently programming at least one die using a single-bit mode and programming at least one die using a multi-bit mode. The data storage device may include a controller coupled to the non-volatile memory that includes a plurality of dies. The controller may be configured to select a group of dies of the plurality of dies to be programmed concurrently, such as a group of dies including a first die and a second die. The controller may assign each die of the group of dies to operate according to one of the single-bit mode or the multi-bit mode. For example, the controller may assign (e.g., determine) at least one die of the group of dies, such as the first die, to operate in the single-bit mode and may assign (e.g., determine) at least one die of the group of dies, such as the second die, to operate in the multi-bit mode.

The controller may be configured to receive data to be stored into the non-volatile memory and to partition the data into a first portion of the data and a second portion of the data. The controller may further be configured to send the first portion and the second portion to the non-volatile memory to be stored in the first die and the second die, respectively. For example, the controller may send the first portion to be stored into one or more blocks (e.g., at one or more addresses) of the first die and may send the second portion to be stored into one or more blocks (e.g., at one or more addresses) of the second die. The controller may be configured to track which blocks (e.g., addresses) of the first die are programmed with the first portion using the single-bit mode and to track which blocks (e.g., addresses) of the second die are programmed with the second portion using the multi-bit mode.

The non-volatile memory may store the first portion into the first die and may store the second portion into the second die. To illustrate, the first portion may be stored into the first die using a single-bit mode and the second portion may be stored into the second die using a multi-bit mode. For example, the non-volatile memory may include first write circuitry and second write circuitry. The first write circuitry may be configured to operate in accordance with the single-bit mode and the second write circuitry may be configured to operate in accordance with the multi-bit mode.

When a number of dies (N) of the data storage device may be programmed concurrently, the non-volatile memory may include a total of less than 2N dies to achieve a target performance (e.g., a data storage rate and/or a total storage capacity). A number of dies that may be used in single-bit mode, of the number of dies (N) that may be programmed concurrently, may depend on the target data storage rate to be achieved.

To account for uneven wear among the dies of the non-volatile memory resulting from the at least one die used in the single-bit mode, the at least one die determined (e.g., selected) to be used in the single-bit mode may be shuffled (e.g., rotated) across the dies (e.g., over time) and need not be restricted to one die at all times. Using the mixed mode programming scheme in the data storage device may result in a cost savings and a power savings as compared to data storage devices that stripe data across multiple dies using a single programming scheme, such as a single-bit programming mode or a multi-bit programming mode. Additionally, a certain amount of die overprovisioning may be required to meet a target total storage capacity. In a first approach, the data storage device may overprovision dies (e.g., include a total number of dies that is greater than a number of dies that can be programmed concurrently) to meet the target total storage capacity. In a second approach, the data storage device may include a total number of dies that is equal to a number of dies that can be programmed concurrently. Accordingly, in the second approach, a total storage capacity may be less than the target total storage capacity. The second approach may result in a total storage capacity that is less than the target total storage capacity, but may result in a lower monetary cost and reduced power consumption as compared to the first approach.

By using the mixed mode programming scheme, a data storage device may achieve a target performance, while maintaining a relatively few number of dies and a relatively low power consumption. For example, based on the mixed mode programming scheme, at least one die may be programmed using a single-bit mode while at least one other die is concurrently programmed using a multi-bit programming scheme. Additionally, the data storage device may rotate which die(s) of a plurality of dies included in the data storage device is programmed according to the single-bit mode to account for uneven wear among the plurality of dies. Accounting for uneven wear may promote endurance (e.g., an operating life-time) of the data storage device. The data storage device using the mixed mode programming scheme may achieve the target performance with fewer dies included in the data storage device than conventional data storage devices that use a single programming mode. As compared to the conventional data storage device, the data storage device using the mixed mode programming scheme may reduce a memory cost (e.g., by 40-50%) and may consume less power due to having a fewer number of dies.

### BRIEF DESCRIPTION OF THE DRAWINGS

FIG. 1 is a block diagram of a particular illustrative embodiment of a system including a data storage device that uses a mixed mode programming scheme;

FIG. 2 is a block diagram illustrating a particular embodiment of components that may be incorporated in the data storage device of FIG. 1;

FIG. 3 is a diagram illustrating certain example operations of the data storage device of FIG. 1;

FIG. 4 is diagram illustrating certain example operations of the data storage device of FIG. 1;

FIG. 5 is diagram illustrating certain example operations of the data storage device of FIG. 1;

FIG. 6 is a diagram illustrating an example of data stored into a non-volatile memory according to a mixed mode programming scheme;

FIG. 7 is a diagram illustrating an example of data stored into a non-volatile memory according to a mixed mode programming scheme;

FIG. 8 is a diagram illustrating an example of data stored into a non-volatile memory according to a mixed mode programming scheme;

FIG. 9 is a flow diagram of a third illustrative method of operating a data storage device; and

FIG. 10 is a flow diagram of a fourth illustrative method of operating a data storage device.

### DETAILED DESCRIPTION

Particular embodiments of the present disclosure are described below with reference to the drawings. In the description, common features are designated by common reference numbers throughout the drawings.

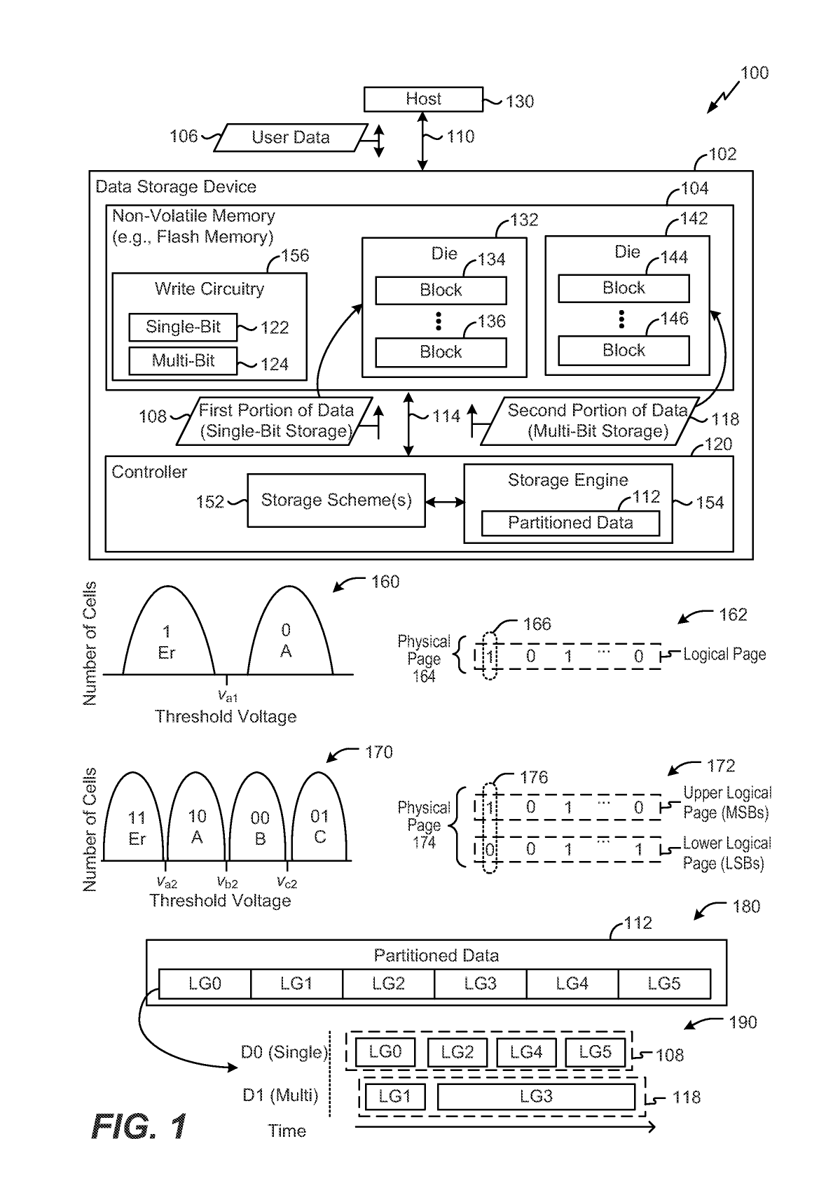

FIG. 1 is a block diagram of a particular illustrative embodiment of an electronic device 100 including a data storage device 102 and a host device 130. The data storage device 102 may be coupled to the host device 130 via a communication path 110, such as a wired communication path and/or a wireless communication path. The data storage device 102 may be embedded within the host device 130, such as in accordance with an embedded MultiMedia Card (eMMC®) (trademark of Joint Electron Devices Engineering Council (JEDEC) Solid State Technology Association, Arlington, Va.) configuration. Alternatively, the data storage device 102 may be removable from (i.e., “removably” coupled to) the host device 130. For example, the data storage device 102 may be removably coupled to the host device 130 in accordance with a removable universal serial bus (USB) configuration.

The host device 130 may issue one or more commands to the data storage device 102, such as one or more requests to read data from or write data to a memory of the data storage device 102. The host device 130 may include a mobile telephone, a music player, a video player, a gaming console, an electronic book reader, a personal digital assistant (PDA), a computer, such as a laptop computer, a notebook computer, or a tablet, any other electronic device, or any combination thereof. The host device 130 may communicate via a host controller, which may enable the host device 130 to read data from and to write data to the data storage device 102. The host device 130 may operate in compliance with a JEDEC Solid State Technology Association industry specification, such as an embedded MultiMedia Card (eMMC) specification or a Universal Flash Storage (UFS) Host Controller Interface specification. The host device 130 may operate in compliance with one or more other specifications, such as a Secure Digital (SD) Host Controller specification, as an illustrative, non-limiting example. The host device 130 may communicate with the data storage device 102 in accordance with another suitable communication protocol.

To further illustrate, the data storage device 102 may be configured to be coupled to the host device 130 as embedded memory, such as in connection with an eMMC configuration, as an illustrative, non-limiting example. The data storage device 102 may correspond to an eMMC device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

The data storage device 102 includes a controller 120 and a non-volatile memory 104. The controller 120 may be coupled to the non-volatile memory 104 via a bus 114, an interface, another structure, or a combination thereof. The non-volatile memory 104 may include a flash memory (e.g., a NAND flash memory or a NOR flash memory). In other implementations, the non-volatile memory 104 may include an erasable programmable read-only memory (EPROM), an electrically-erasable programmable read-only memory (EEPROM), a read-only memory (ROM), a one-time programmable memory (OTP), another type of memory, or a combination thereof.

The non-volatile memory 104 may include write circuitry 156 and a plurality of dies. The plurality of dies may include or correspond to a number of dies that may be concurrently programmed by the non-volatile memory 104, or may include a number of dies that is greater than the number of dies that can be concurrently programmed. The plurality of dies may include a first die 132 and a second die 142. Although the non-volatile memory 104 is illustrated as including two dies 132, 142, the non-volatile memory 104 may include more than two dies. Each die of the plurality of dies may include multiple blocks of storage elements, such as multiple erase blocks. For example, the first die 132 may include blocks 134, 136 and the second die 142 may include the blocks 144, 146. Each of the blocks 134-136, 144-146 may include one or more wordlines (also referred to herein as “physical pages”). Each wordline may include one or more storage elements (e.g., one or more memory cells). Although each of the dies 132, 142 is illustrated as including two blocks, each die 132, 142, may include less than two blocks or more than two blocks. Each of the blocks 134-136, 144-146 may include a same number of wordlines or a different number of wordlines.

Each of the dies 132, 142 may be configurable to operate as a Single-Level Cell (SLC) memory and as a Multi-Level Cell (MLC) memory. For example, a particular die may be configurable to operate as the SLC memory or the MLC memory based on a mode. To illustrate, the particular dies may be configured to operate as the SLC memory based on a single-bit mode or may be configured to operate as the MLC memory based on a multi-bit mode. When a particular die is operating as the SLC memory, a first portion of the particular die may be configured to store a single-bit per storage element. When the particular die is operating as the MLC memory, a second portion of the particular die may be configured to store multiple bits per storage element. The particular die configured as the MLC memory may support multi-bits per storage element configurations, such as a 2 bits per storage element configuration, a 3 bits per storage element configuration, a 4 bits per storage element configuration, or other configurations of more than 4 bits per storage element.

The write circuitry 156 may include single-bit write circuitry 122 and multi-bit write circuitry 124. The single-bit write circuitry 122 may be configured to operate in accordance with the single-bit mode. For example, when a particular die is determined to operate as the SLC memory (e.g., operate in the single-bit mode), the single-bit write circuitry 122 may be used to program the particular die to store a single-bit per storage element. The multi-bit write circuitry 124 may be configured to operate in accordance with the multi-bit mode. For example, when a particular die is determined to operate as the MLC memory (e.g. operate in the multi-bit mode), the multi-bit write circuitry 124 may be used to program the particular die to store multiple bits per storage element. Although the write circuitry 156 is depicted in FIG. 1 as separate from the dies 132, 142, each of the dies 132, 142 may include or be coupled to corresponding write circuitry.

The controller 120 may receive data and commands (e.g., instructions) from the host device 130 and may send data to the host device 130. As an illustrative example, the controller 120 may receive user data 106 to be stored into the non-volatile memory 104. The controller 120 may send data and commands to the non-volatile memory 104 and may receive data from the non-volatile memory 104. For example, the controller 120 may send one or more write commands and/or one or more read commands to the non-volatile memory 104.

The controller 120 may include one or more storage schemes 152 and a storage element 154. Each of the one or more schemes 152 may be associated with, based on, or designed to achieve a target data storage rate, to have a target storage capacity, and/or to promote an endurance (e.g., an operating life-time) of the data storage device 102. The storage scheme(s) 152 may be associated with a mixed mode programming scheme that is used to determine at least one die of the non-volatile memory 104 to be programmed using the single-bit mode and to determine at least one die of the non-volatile memory 104 to be programmed using the multi-bit mode. The storage scheme(s) 152 may indicate a number of dies that can be programmed concurrently, indicate a pattern or algorithm to select a group of dies to be programmed concurrently, indicate a number of dies of the group of dies to be programmed according to the single-bit mode, indicate a number of dies of the group of dies to be programmed according to the multi-bit mode, indicate a pattern or algorithm to determine which dies of the group of dies are to use the single-bit mode, indicate a pattern or algorithm to determine which dies of the group of dies are to use the multi-bit mode, indicate a number of bits to be stored per storage element for the multi-bit mode, indicate a number of blocks available to be used for each die included in the group of dies (e.g., a number of blocks to be used in each mode), indicate a manner in which data to be stored into the non-volatile memory 104 is to be partitioned, and/or indicate an order in which data is to be provided to each die of the group of dies, as illustrative, non-limiting examples.

To illustrate, the storage scheme(s) 152 may indicate that a group of dies to be programmed concurrently may include a number of dies that is less than or equal to a total number of dies of the plurality of dies. In a particular embodiment, the number of dies that can be programmed concurrently may be a multiple of two. For example, the storage scheme(s) 152 may dictate that a group of two dies, such as the first die 132 and the second die 142 are to be selected to be programmed concurrently. The storage scheme(s) 152 may also indicate (e.g., dictate) that one die, such as the first die 132, is to be programmed using the single-bit mode and that another die, such as the second die 142, is to be programmed using the multi-bit mode. When the first die 132 is to be programmed according to the single-bit mode, the storage scheme(s) 152 may indicate and/or identify a first number of blocks of the first die 132 that are available to be programmed according to the single-bit mode. When the second die 142 is to be programmed according to the multi-bit mode, the storage scheme(s) 152 may indicate and/or identify a second number of blocks of the second die 142 that are available to be programmed according to the multi-bit mode. The first number of blocks may be greater than or equal to the second number of blocks.

To illustrate, the storage engine 154 may be configured to determine a group of dies of the plurality of dies that may be programmed concurrently based on the storage scheme(s) 152. The storage engine 154 may also be configured to determine to use the first die 132 in the single-bit mode and to use the second die 142 in the multi-bit mode. For example, the storage engine 154 may determine to use the first die 132 and the second die 142 based on the storage scheme(s) 152. When the first die 132 is determined to be programmed according to the single-bit mode, the storage engine 154 may allocate a first number of blocks of the first die 132 to be programmed according to the single-bit mode. When the second die 142 is determined to be programmed according to the multi-bit mode, the storage engine 154 may allocate a second number of blocks of the second die 142 to be programmed according to the multi-bit mode. The first number of blocks may be greater than the second number of blocks.

The storage engine 154 may be configured to receive data, such as the user data 106, to be stored at the non-volatile memory 104. The storage engine 154 may partition the received data to generate partitioned data 112. The partitioned data 112 may include at least a first portion 108 and a second portion 118. To illustrate, the storage engine 154 may partition the data to generate multiple data groups (e.g., a plurality of logical groups), as described further herein. Each data group may include a number of bits less than or equal to a number of bits that may be stored in a single wordline of the dies 132, 142 that is configured to store a single-bit per storage element. A first number of data groups of the multiple data groups may correspond to or be included in the first portion 108 and a second number of data groups of the multiple data groups may correspond to or be included in the second portion 118. The first portion 108 may be generated to be programmed into the first die 132 according to the single-bit mode and the second portion 118 may be generated to be programmed into the second die 142 according to the multi-bit mode.

The storage engine 154 may send the partitioned data 112 (e.g., the user data 106) to be stored at the non-volatile memory 104. For example, the controller 120 may send the first portion 108 and one or more first write commands to cause the non-volatile memory 104 to store the first portion 108 into the first die 132 (e.g., at one or more specified address) according to the single-bit mode. The one or more first write commands may include a first indicator, such as a flag (e.g., a bit location of the one or more first write commands having a particular bit value, such as a logical “1”), to indicate that the first portion 108 is to be programmed using the single-bit write circuitry 122. As another example, the controller 120 may send the second portion 118 and one or more second write commands to cause the non-volatile memory 104 to store the second portion 118 into the second die 142 (e.g., at one or more specified addresses) according to the multi-bit mode. The one or more second write commands may include a second indicator, such as a flag (e.g., a bit location of the one or more second write commands having a particular bit value, such as a logical “0”) to indicate that the first portion 118 is to be programmed using the multi-bit write circuitry 124.

The first portion 108 may be stored into the first die 132 of the plurality of dies using the single-bit mode. For example, the first portion 108 may be stored into the first die 132 as a single-bit per storage element. The second portion 118 may be stored into the second die 142 of the plurality of dies using the multi-bit mode. For example, the second portion 118 may be stored into the second die 142 as multiple bits per storage element. The first portion 108 and the second portion 118 may be sent (e.g., provided) to the non-volatile memory 104 and stored directly into one or more blocks of the first die 132 and the second die 142, respectively. Alternatively, the data storage device 102 may include a binary cache (not shown) into which the data is stored prior to being stored in the dies 132, 142. For example, the non-volatile memory 104 may include the binary cache and the first portion 108 and/or the second portion 118 may be temporarily stored (e.g., cached) into the binary cache prior to being stored into one or more blocks of the first die 132 and the second die 142, respectively. Alternatively or additionally, each of the one or more of the dies 132, 142 may include or correspond to a different binary cache. To illustrate, when the data to be stored into the non-volatile memory 104 may be partitioned into the multiple data groups, the multiple data groups may be stored into the binary cache of the data storage device 102 prior to being stored into the dies 132, 142.

When the first portion 108 is stored into the first die 132 using the single-bit mode, each storage element of the first die 132 into which the first portion 108 is stored may store a single-bit per storage element (e.g., each storage element is programmed to one of two states, such as states “Er” and “A”). A first graph 160 illustrates voltage states in a histogram showing a number of storage elements, for each threshold voltage value, when a die, such as the first die 132, is programmed according to the single-bit mode. For example, the voltage states “Er” and “A” are depicted relative to reference voltage Vₐ₁. Accordingly, each of the voltage states “Er” and “A” has a corresponding voltage value range based on the reference voltages Vₐ₁. For example, the voltage state “Er” of the first graph 160 has a voltage value (corresponding to a data value of “1”) that is less than a reference voltage Vₐ₁ of the first graph 160. As another example, the voltage state “A” 184 has a voltage value (corresponding to a data value of “0”) that is greater than the reference voltage Vₐ of the first graph 160.

An illustrative, non-limiting example of a first physical page 164 of the first die 132 storing data according to the single-bit mode is depicted at 162. The first physical page 164 may include multiple storage elements that each store a single-bit value (e.g., a data value of “0” or “1”). For example, an illustrative storage element 166 of the first physical page 164 may be programmed to a data value of “1” that corresponds to the state “Er”. The first physical page 164 may be included in or correspond to a wordline of one of the blocks 134-136 of the first die 132. Although the first physical page 164 is depicted as including four storage elements, the first physical page 164 may include any number of storage elements. The first physical page 164 may be associated with a logical page of data values. The logical page of data values may have been programmed into the storage elements of the first physical page 164 using the single-bit write circuitry 122.

When the second portion 118 is stored into the second die 142 using the multi-bit mode, each storage element of the second die 142 into which the second portion 118 is stored may store multiple bits per storage element, such as two bits per storage element (e.g., each storage element is programmed to one of four states, such as states “Er”, “A”, “B”, and “C”). A second graph 170 illustrates voltage states in a histogram showing a number of storage elements, for each threshold voltage value, when a die, such as the second die 142, is programmed according to the multi-bit mode. For example, the voltage states “Er”, “A”, “B”, and “C” are depicted relative to reference voltage Vₐ₂, V_{b2}, V_{c2}. Accordingly, each of the voltage states “Er”, “A”, “B”, and “C” has a corresponding voltage value range based on the reference voltages Vₐ₂, V_{b2}, V_{c2}. For example, the voltage state “Er” of the second graph 170 has a voltage value (corresponding to a data value of “1 1”) that is less than a reference voltage Vₐ₂ of the second graph 170. As another example, the voltage state “A” has a voltage value (corresponding to a data value of “1 0”) that is greater than or equal to the reference voltage Vₐ₂ and less than the reference voltage V_{b2}. As another example, the voltage state “B” has a voltage value (corresponding to a data value of “0 0”) that is greater than or equal to a reference voltage V_{b2} and less than a reference voltage V_{c2}. As another example, the voltage state “C” has a voltage value (corresponding to a data value of “0 1”) that is greater than the reference voltage V_{c2} of the second graph 170.

An illustrative, non-limiting example of a second physical page 174 of the second die 142 storing data according to the multi-bit mode is depicted at 172. The second physical page 174 may include multiple storage elements that each store a two bit value (e.g., a data value of “0 0,” “0 1,” “1 0,” or “1 1”). For example, an illustrative storage element 176 of the second physical page 174 may be programmed to a data value of “1 0” that corresponds to the state “A”. The second physical page 174 may be included in or correspond to a wordline of one of the blocks 144-146 of the second die 142. Although the second physical page 174 is depicted as including four storage elements, the second physical page 174 may include any number of storage elements. In an illustrative, non-limiting example, the second physical page 174 includes a same number of storage elements as the first physical page 164. The second physical page 174 may be associated with multiple logical pages of data values, such as an upper logical page and a lower logical page. For example, the upper logical page may correspond to most significant bits (MSBs) of the data values programmed into the storage elements of the second physical page 174 and the lower logical page may correspond to least significant bits (LSBs) of the data values programmed into the storage elements of the second physical page 174. Each of the data values of the multiple logical data values may have been programmed into the storage elements of the second physical page 174 using the multi-bit write circuitry 124. Although the second graph 170 and the physical page 174 have been described as being associated with a multi-bit mode that stores two bits per storage element, the multi-bit mode may be associated with storage of more than two bits per storage element.

An illustrative, non-limiting example of the partitioned data 112 is depicted at 180. The partitioned data 112 may include data, such as the user data 106, that is partitioned into multiple data groups LG0-LG5 (e.g., a plurality of logical groups), such as data partitioned based on the one or more storage schemes 152. For example, the partitioned data 112 may include a first data group LG0, a second data group LG1, a third data group LG2, a fourth data group LG3, a fifth data group LG4, and a sixth data group LG5. A first number of data groups of the multiple data groups LG0-LG5 may correspond to or be included in the first portion 108. For example, the first data group LG0, the third data group LG2, the fifth data group LG4, and the sixth data group LG5 may be associated with the first portion 108. Additionally, a second number of data groups of the multiple data groups LG0-LG5 may correspond to or be included in the second portion 118. For example, the second data group LG1 and the fourth data group LG3 may be associated with the second portion 118. Each of the data groups associated with the first portion 108 may include a corresponding number of bits that is less than or equal to a number of storage elements included in a wordline of a die to be programmed according to the single-bit mode, such a number of storage elements of the first physical page 164 that may be included in the first die 132. Each of the data groups associated with the second portion 118 may include a corresponding number of bits that is less than or equal to a number of storage elements included in a wordline of a die to be programmed according to the multi-bit mode, such as a number of storage elements of the second physical page 174 that may be included in the second die 142.

The multiple data groups LG0-LG5 of the partitioned data 112 may be arranged based on an order in which the multiple data groups LG0-LG5 are to be provided to one or more dies, such as the first die 132 and the second die 142, as described further herein. For example, the storage engine 154 may arrange the multiple data groups LG0-LG5 to be sent to the non-volatile memory 104.

An illustrative, non-limiting example of an order in which the multiple data groups LG0-LG5 may be provided to and programmed into one or more dies is depicted at 190. For example, the multiple data groups LG0-LG5 may be programmed into a first die D0, such as the first die 132, operating in the single-bit mode and a second die D1, such as the second die 142, operating in the multi-bit mode. To illustrate, the first data group LG0 may be provided to the first die D0 and stored in a first logical page of the first die D0 (e.g., a first wordline of the first die D0). The first data group LG0 may be programmed into the first die D0 using the single-bit write circuitry 122. The second data group LG1 may be provided to the second die D1 after the first data group LG0 is provided to the first die D0. The second data group LG1 may be stored at a first logical page, such as an lower logical page, of a first wordline of the second die D1. The second data group LG1 may be programmed into the second die D1 using the multi-bit write circuitry 124. A duration of storing a wordline in the first die D0 using the single-bit mode may be comparable to a duration of time to store the lower logical page into the second die using the multi-bit mode.

The third data group LG2 may be provided to the first die D0 after the second data group LG1 is provided to the second die D1. The third data group LG2 may be stored in a second logical page of the first die D0 (e.g., a second wordline of the first die D0). The third data group LG2 may be programmed into the first die D0 using the single-bit write circuitry 122. The fourth data group LG3 may be provided to the second die D1 and stored in a second logical page, such as a upper logical page, of the first wordline of the second die D1. The fourth data group LG3 may be programmed into the second die D1 using the multi-bit write circuitry 124. A duration of time associated with storing (e.g., programming) the upper logical page may be greater than an amount of time to store a wordline in the first die D0 operating in the single-bit mode. For example, a plurality of data groups may be able to be stored at the first die D0 while the fourth data group LG3 is written into the upper logical page of the second die D1.

The fifth data group LG4 may be provided to the first die D0 after the fourth data group LG3 is provided to the second die D1. The fifth data group LG4 may be stored in a third logical page of the first die D0 (e.g., a third wordline of the first die). The sixth data group LG5 may be provided to the first die D0 after the fifth data group LG4 is stored in a fourth logical page of the first die D0 (e.g., a fourth wordline of the first die). The fifth data group LG4 and the sixth data group LG5 may be programmed into the first die D0 using the single-bit write circuitry 122. Accordingly, the first portion 108 may be programmed into the first die D0 and the second portion 118 may be programmed into the second die D1. As illustrated at 190, the first die D0 using the single-bit mode may store four wordlines worth of data while the second die D1 using the multi-bit mode may store a single wordline worth of data. When a block of first die D0 operating according to the single-bit mode includes a same number of wordlines as a block of the second die D1 operating in the multi-bit mode (e.g., two bits per storage element), the block of the first die D0 may be filled at a rate that is four times faster than a rate at which the block of the second die may be filled (e.g., multiple wordlines of the first die D0 may be programmed while a single wordline of the second die D1 is programmed).

By programming the first die D0 using the single-bit mode and programming the second die D1 using the multi-bit mode, the dies D0, D1 may be programmed with six data groups during a time period that is associated with programming a single wordline into a die using the multi-bit mode, such as the second die D1. If both the first die D0 and the second die D1 were programmed using the multi-bit mode, four data groups would be programmed during the time period associated with programming a single wordline into a die using the multi-bit mode. For example, if both the first die D0 and the second die D1 were programmed using the multi-bit mode, two data groups would be programmed into a first wordline of the first die D0 and two data groups would be programmed into a second wordline of the second die D1. Therefore, to store six data groups into the first die D0 and the second die D1 that are operating in the multi-bit mode would take longer than that of a time period that is associated with programming a single wordline into a die using the multi-bit mode. Accordingly, a latency associated with storing data into the non-volatile memory 104 (including the first die D0 and the second die D1) using the single-bit mode and the multi-bit mode is less than a latency associated with storing the data using only the multi-bit mode.

During operation, the data storage device 102 may receive the user data 106 from the host device 130 to be stored into the non-volatile memory 104. The storage engine 154 may divide the user data 106 into the partitioned data 112 based on the storage scheme(s) 152. The partitioned data 112 may include the first portion 108 and the second portion 118. The first portion 108 may include one or more first data groups, such as the first data group LG0, the third data group LG2, the fifth data group LG4, and the sixth data group LG5. The second portion 118 may include one or more second data groups, such as the second data group LG1 and the fourth data group LG3.

The storage engine 154 may determine at least one die of the plurality of dies to be used in the single-bit mode and may determine at least one die of the plurality of dies to be used in the multi-bit mode. For example, the storage engine 154 may determine that the first die 132 is to use the single-bit mode and may determine that the second die 142 is to use the multi-bit mode. The storage engine 154 may send the first portion 108 and the second portion 118 to the non-volatile memory 104. The first portion 108 may be stored into the first die 132 using the single-bit write circuitry 122 and the second portion 118 may be stored into the second die 142 using the multi-bit write circuitry 124.

One or more of the mixed mode programming techniques described with reference to FIG. 1 may enable storing data at the non-volatile memory 104 according to a mixed mode programming scheme to achieve one or more target performance characteristics (e.g., a data rate, a storage capacity, an endurance). For example, based on the mixed mode programming scheme, at least one die may be programming using a single-bit mode while at least one other die is concurrently programmed using a multi-bit programming scheme. By using the mixed mode programming scheme, the data storage device 102 may achieve a target data storage rate while maintaining a relatively few number of dies as compared to other data storage devices that program dies according to a single programming mode because, during a time period for a die operating in the multi-bit mode to store data into a wordline, a die operating in a single-bit mode may store more data (into more than two wordlines) than the die operating in the multi-bit mode.

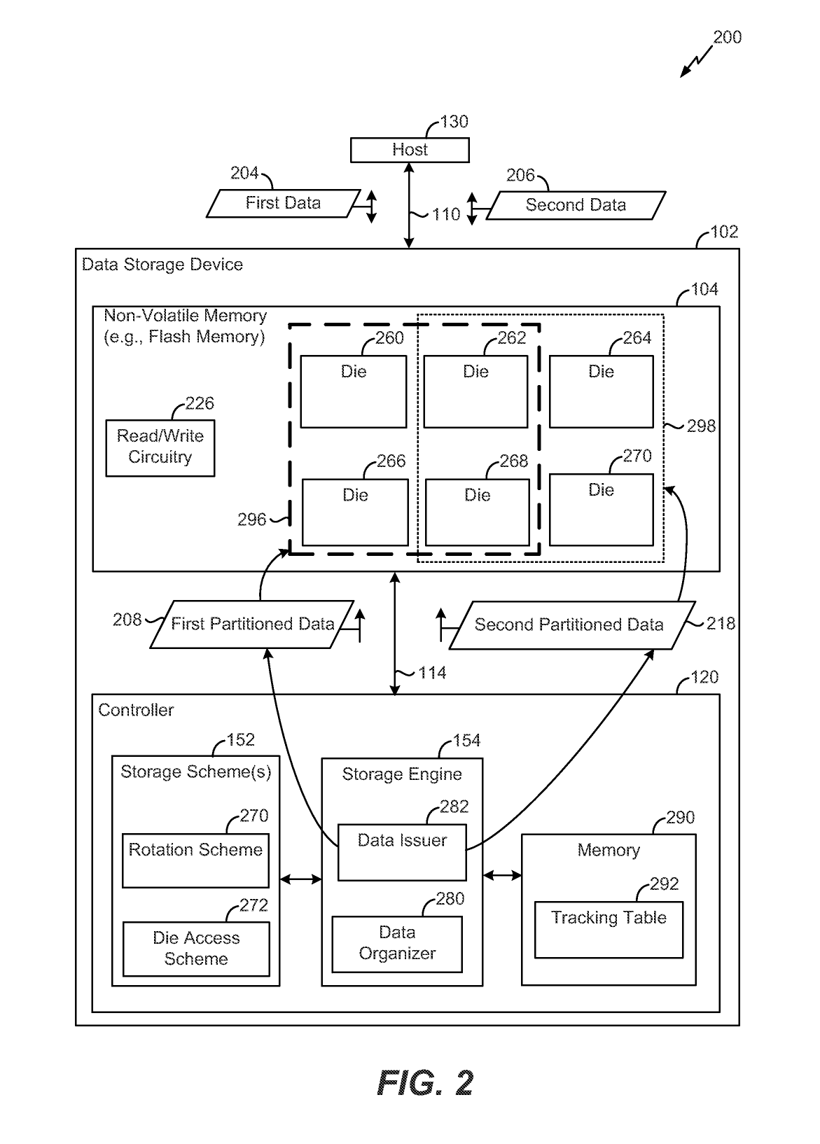

Referring to FIG. 2, a particular illustrative embodiment of the data storage device 102 of FIG. 1 showing additional detail of the non-volatile memory 104 and the controller 120 is depicted. The non-volatile memory 104 may include read/write circuitry 226 and multiple dies 260-270, and the controller 120 may include the storage scheme(s) 152, the storage engine 154, and a memory 290, as described further herein.

The data storage device 130 may be coupled to the host device 130 and configured to receive data from the host device 130. For example, the host device 130 may send first data 204 and second data 206 to be stored to the non-volatile memory 104 of the data storage device 102. The first data 204 and/or the second data 206 may include or correspond to the user data 106 of FIG. 1.

The non-volatile memory 104 may include the multiple dies 260-270. For example, the multiple dies 260-270 may include a first die 260, a second die 262, a third dies 264, a fourth die 266, a fifth die 268, and a sixth die 270. Each of the multiple dies 260-270 may be configured as described with reference to the first block 132 and the second block 142 of FIG. 1. For example, each of the multiple dies 260-270 may be programmed according to a single-bit mode or a multi-bit mode. The total number of dies included in the non-volatile memory 104 may be based on a performance characteristic (e.g., a storage capacity, a storage capacity, and/or an endurance) of the data storage device 102.

The read/write circuitry 226 is configured to read data from or write data to one or more of the multiple dies 260-270. The read/write circuitry 226 may include or correspond to the write circuitry 156 of FIG. 1. The read/write circuitry 226 may be configured to operate in accordance with the single-bit mode and/or the multi-bit mode. Although the read/write circuitry 226 is depicted in FIG. 2 as separate from the multiple dies 260-260, each of the multiple dies 260-270 may include or be coupled to corresponding read/write circuitry. The read/write circuitry 226 may be configured to concurrently write to (e.g., program) a number of dies (N). The number of dies (N) may be less than or equal to a total number of dies included in the non-volatile memory. For example, when the non-volatile memory 104 includes the six multiple dies 260-270, the number of dies (N) that may be programmed concurrently may be four.

The controller 120 may include the one or more storage scheme(s) 152 that are accessible to the storage engine 154. The one or more storage scheme(s) 152 may include a rotation scheme 270 and a die access scheme 272. The rotation scheme 270 may identify (e.g., dictate) a pattern or a scheme of selecting different groups of dies of the multiple dies 260-270. For example, the rotation scheme 270 may dictate that a first group 296 (as indicated by a large-dashed box) includes the first die 260, the second die 262, the fourth die 266, and the fifth die 268. As another example, the rotation scheme 270 may dictate that a second group 298 (as indicted by a small-dashed box) includes the second die 262, the third die 264, the fifth die 268, and the sixth die 270. The die access scheme 272 may be based on a data storage rate of the non-volatile memory 104. For example, the data storage device 102 may be designed to achieve the data storage rate based on a product performance requirement (e.g., one or more design parameters) of the data storage device 102. To illustrate, the die access scheme 272 may have been determined to satisfy the product performance requirement. The die access scheme 272 may identify (e.g., dictate) how many die(s) of a particular group of dies are to be programmed according to a single-bit mode and/or a multi-bit mode. Additionally or alternatively, the die access scheme 272 may indicate a number of blocks of each die in the particular group of dies to be programmed according to a given mode, such as the single-bit mode or the multi-bit mode. The die access scheme 272 may also indicate an order in which data (e.g., partitioned data) is to be communicated from the controller 120 to the non-volatile memory 104, such as communicated via the bus 114, and/or an order in which data (e.g., partitioned data) is to be written into each of the particular group of dies. The controller 120 may apply the rotation scheme 270 and/or the die access scheme 272 to enable each die of the multiple dies 260-270 to be fully programmed (e.g., a particular die is able to store an amount of data up to a corresponding storage capacity). The rotation scheme 270 and/or the die access scheme 272 may promote endurance of the non-volatile memory 104 by controlling which portions of each of the multiple dies 260-270 are programmed according to the single-bit mode. Although described as separate schemes, the rotation scheme 270 and the die access scheme 272 may be included in a single scheme.

The storage engine 154 may be configured to access one or more of the storage schemes 152 and to apply the one or more storage schemes 152. For example, the storage engine 154 may identify a particular group of dies based on the rotation scheme 270, determine a corresponding mode for each die included in the particular group of dies based on the rotation scheme 270 and/or the die access scheme 272, and send data to be stored to the particular group of dies based on the die access scheme 272.

The storage engine 154 may include a data organizer 280 and a data issuer 282. The data organizer 280 may receive data to be programmed into the non-volatile memory 104, such as the first data 204 and the second data 206, and may generate corresponding partitioned data, such as the partitioned data 112, as described with reference to FIG. 1. For example, the data organizer 280 may generate the corresponding partitioned data based on the die access scheme 272. To illustrate, the data organizer 280 may receive the first data 204 and may generate first partitioned data 208. Additionally, the data organizer 280 may receive the second data 206 and may generate the second partitioned data 218.

The data issuer 282 may be configured to send partitioned data to the non-volatile memory 104 for storage. For example, the data issuer 282 may send the first partitioned data 208 to the non-volatile memory 104 to be stored into the first group 296 (as indicated by a large-dashed box) and may send the second partitioned data 218 to the non-volatile memory 104 to be stored into the second group 298 (as indicted by a small-dashed box). The read/write circuitry 226 may be used to write the first partitioned data 208 into the first group 296 and to write the second partitioned data 218 into the second group 298. When the partitioned data 208, 218 includes multiple data groups, such as the data groups LG0-LG5, the data issuer 282 may individually send each data group of the partitioned data 208, 218 along with or as part of a corresponding write command that indicates a mode (e.g., the single-bit mode or the multi-bit mode) to be used when writing the data group.

Additionally or alternatively, the storage engine 154 may be configured to enable data read from the non-volatile memory 104 to be sent to the host device 130. For example, the host device 130 may send a read request to the data storage device 102. Based on the read request, the controller 120 may identify one or more locations (e.g., address) of the non-volatile memory 104 to be read and may issue one or more read commands to the non-volatile memory 104. The read/write circuitry 226 may read data from one or more of the multiple dies 260-270 based on the one or more read commands received from the controller 120. The data read based on the one or more read commands may be provided to the controller 120, such as provided to the data organizer 280. The data organizer 280 may arrange the data in an order (e.g., a sequence) that is expected by the host device 130. For example, the data organizer 280 may arrange the data based on a tracking table 292 that indicates an order in which the data was stored into the non-volatile memory 104 prior to being read from the non-volatile memory 104. After the data is arranged, the controller 120 may send the data to the host device 130.

The memory 290 of the controller 120 may include a single memory component or may correspond to multiple distinct memory components and/or multiple different types of memory components. For example, all or part of the memory 290 may correspond to a random access memory (RAM) or a high-speed cache. All or part of the memory 290 may correspond to another type of memory, such as a non-volatile memory included in the controller 120. The memory 290 may include the tracking table 292. The tracking table 292 may be generated, maintained, and updated to track data stored in each of the multiple dies 260-270. The tracking table 292 may track an order in which data is sent to the non-volatile memory 104 and/or programmed into each of the multiple dies 260-270, which blocks and/or wordlines are programmed according to a single-bit mode, which blocks and/or wordlines are programmed according to a multi-bit mode, and/or which blocks and/or wordlines of different dies are included in a particular group, as illustrative, non-limiting examples. The tracking table 292 may be updated each time data is sent to and/or programmed into the non-volatile memory 104. Additionally, the tracking table 292 may be accessed, such as by the data organizer 280, to arrange read data in an order expected by the host device 130. To illustrate, the controller 120 may be configured to track which blocks (e.g., addresses) of a particular die (e.g., the first die 260) are programmed using the single-bit mode and to track which blocks (e.g., addresses) of the particular die are programmed using the multi-bit mode.

During operation, the data storage device 102 may receive the first data 204 to be stored at the non-volatile memory 104. The controller 120 may select the first group 296 of the plurality of dies 260-270. For example, the first group 296 (including the first die 260, the second die 262, the fourth die 266, and the fifth die 268) may be selected to store the first data 204. To illustrate, the first group 296 may be selected from the plurality of dies 260-270 based on the rotation scheme 270. The first group 296 may include less than all of the plurality of dies 260-270 included in the non-volatile memory 104.

The controller 120 may assign each die of the first group 296 to operate according to one of the single-bit mode or the multi-bit mode. For example, each die of the first group 296 may be assigned to operate according to one of the single-bit mode or the multi-bit mode based on the die access scheme 272. The die access scheme 272 may identify a first number of dies of the first group 296 to operate according to the single-bit mode and/or a second number of dies of the first group 296 to operate according to the multi-bit mode. Each die of the first group 296 may operate in a corresponding assigned mode during storage of the first data 204 into the non-volatile memory 104. Additionally, the controller 120 may determine which block(s) and/or wordline(s) of each die in the first group 296 is to be used to store a corresponding portion of the first data 204 (e.g., a corresponding portion of the first partitioned data 208).

To illustrate, the controller 120 may determine that the first die 260 is to use the single-bit mode and may determine that the second die 262, the fourth die 266, and the fifth die 268 are to use the multi-bit mode. For example, the controller 120 may determine, based on the die access scheme 272, to use the first die 260 in the single-bit mode and to use the dies 262, 266, 268 in the multi-bit mode. The controller 120 may allocate multiple blocks of the first die 260 to be programmed using the single-bit mode. Accordingly, the controller 120 may update the tracking table 292 to track which blocks of the first die 260 are associated with (e.g., assigned to or programmed according to) the single-bit mode.

The controller 120 may partition the first data 204 to generate the first partitioned data 208 that is configured to be stored into the first group 296. For example, the controller 120 may partition the first data 204 based on the die access scheme 272 that was used to identify which dies of the first group 296 are to use the single-bit mode and which dies of the first group 296 are to use the multi-bit mode. The controller 120 may send the first partitioned data 208 to the non-volatile memory 104, and the first partitioned data 208 may be stored into the dies 260, 262, 266, 268 of the first group 296. For example, the first partitioned data 208 may be stored into the first group 296 using the read/write circuitry 226.

After receiving the first data 204, the data storage device 102 may receive the second data 206 to be stored at the non-volatile memory 104. The controller 120 may select (e.g., identify) the second group 298 (including the second die 262, the third die 264, the fifth die 268, and the sixth die 270) of the plurality of dies 260-270. For example, the second group 298 may be selected to store the data 206. The second group 298 may be selected from the plurality of dies 260-270 based on the rotation scheme 270. The second group 298 may include a same number of dies as the first group 298.

The controller 120 may assign each die of the second group 298 to operate according to a corresponding assigned mode during storage of the second data 206 into the non-volatile memory 104. To illustrate, the controller 120 may determine that the second die 262 is to use the single-bit mode and may determine that the third die 264, the fifth die 268, and the sixth die 270 are to use the multi-bit mode.

The controller 120 may partition the second data 206 to generate the second partitioned data 218 that is configured to be stored into the second group 298. For example, the controller 120 may partition the second data 206 based on the die access scheme 272 that was used to identify which dies of the second group 298 are to use the single-bit mode and which dies of the second group 298 are to use the multi-bit mode. The controller 120 may send the second partitioned data 218 to the non-volatile memory 104. The second partitioned data 218 may be stored into the dies 262, 264, 268, 270 of the second group 298.

As an illustrative, non-limiting example, the second die 262 may be used in the multi-bit mode when the second die 262 is included in the first group 296 and the second die may be used in the single-bit mode when the second die 262 is included in the second group 298. Accordingly, when the first partitioned data 208 is stored into the first group 296, a portion of the first partitioned data 208 may be stored into the second die 262 according to the multi-bit mode. Additionally, when the second partitioned data 218 is stored into the second group 298, a portion (e.g., a particular portion) of the second partitioned data 218 may be stored into the second die 262 according to the single-bit mode.

By using the rotation scheme 270, different groups of dies may be selected to be programmed with data received from the host device 130. Each time a group of dies is selected, at least one die may be selected to operate according to the single-bit mode. For example, at a first time a particular group of dies is selected, a first die may use the single-bit mode, and at a second time the particular group of dies is selected, a die other than the first die may use the single-bit mode and the first die may use the multi-bit mode. Accordingly, the data storage device 120 may rotate which die(s) of the multiple dies 260-270 included in the data storage device 102 are programmed according to the single-bit mode to account for uneven wear among the plurality of dies. By accounting for uneven wear, the rotation scheme 270 may be used to promote endurance (e.g., an operating life-time) of the data storage device 102.

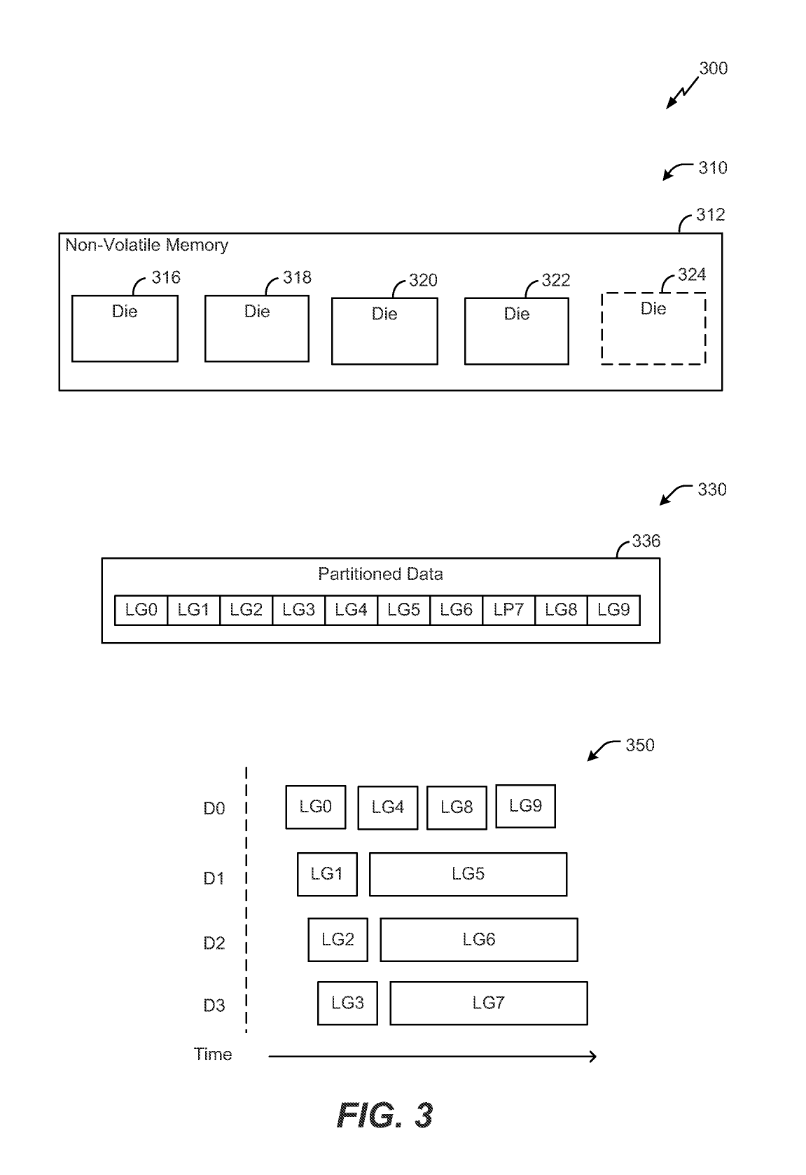

FIG. 3 is a diagram illustrating an example of using a mixed mode programming scheme to store data into a non-volatile memory of a data storage device. The mixed mode programming scheme may include a single-bit mode associated with storing one bit per storage element and a multi-bit mode associated with storing two bits per storage element. For example, the data may be stored into a non-volatile memory of the data storage device, such as the data storage device 102 of FIGS. 1-2.

A non-volatile memory 312 of the data storage device is depicted at 310. The non-volatile memory may include a plurality of dies 316-324. For example, the plurality of dies 316-324 may include a first die 316, a second die 318, a third die 320, a fourth die 322, and a firth die 324. As depicted in FIG. 3, the non-volatile memory 312 may include a total number of five dies; however, the total number of dies may be less than five dies or greater than five dies. For example, the non-volatile memory 312 may have a total of four dies 316-322 and the fifth die 324 may be omitted from the non-volatile memory.

The non-volatile memory 312 may be configured to concurrently program four dies. Accordingly, a group of dies to be programmed may be selected based on a rotation scheme, such as the rotation scheme 270 of FIG. 2. Additionally, a number of dies of the group of dies to use a single-bit mode may be identified based on a die access scheme, such as the die access scheme 272 of FIG. 2. Accordingly, at least one die of the group of dies may be determined (e.g., selected) to use the single-bit mode.

The data to be stored into the non-volatile memory 312 may be partitioned to generate partitioned data 336, as illustrated at 330. The data may be partitioned in accordance with the die access scheme. For example, the data may be partitioned into multiple data groups LG0-LG9 based on the group of dies to store the data, such as based on a number of dies using the single-bit mode and a number of dies using the multi-bit mode. For example, the multiple logical groups LG0-LG9 (e.g., a plurality of logical groups) may include a first data group LG0, a second data group LG1, a third data group LG2, a fourth data group LG3, a fifth data group LG4, a sixth data group LG5, a seventh data group LG6, an eighth data group LG7, a ninth data group LG8, and a tenth data group LG9. The multiple groups LG0-LG9 may be arranged based on an order in which the multiple groups are to be provided to (e.g., stored in) the non-volatile memory based on the die access scheme.

An illustrative, non-limiting example of an order in which the multiple data groups LG0-LG9 may be provided to (e.g., programmed into) dies D0-D3 is depicted at 350. The dies D0-D3 are representative of a group of four dies of the non-volatile memory 312. For example, the dies D0-D3 may include a first die D0 using the single-bit mode, a second die D1 using the multi-bit mode, a third die D2 using the multi-bit mode, and a fourth die D3 using the multi-bit mode.

To program the partitioned data 336 into the dies D0-D3, the first data group LG0 may be provided to the first die D0 and stored in a first logical page of the first die D0 (e.g., a first wordline of the first die D0). Providing the first data group LG0 may be followed by the second data group LG1, the third data group LG2, and the fourth data group LG3 which are provided to the second die D1, the third die D2, and the fourth die D3, respectively. Each of the data groups LG1-LG3 may be stored at a first logical page, such as an upper logical page, of a corresponding wordline of the respective die into which the data group is stored.

The fifth data group LG4 may be provided to the first die D0 after the fourth data group LG3 is provided to the fourth die D3. The fifth data group LG4 may be stored in a second logical page of the first die D0 (e.g., a second wordline of the first die D0). Providing the fifth data group LG4 may be followed by the sixth data group LG5, the seventh data group LG6, and the eighth data group LG7 which are provided to the second die D1, the third die D2, and the fourth die D3, respectively. Each of the data groups LG5-LG6 may be stored at a second logical page, such as a lower logical page, of the corresponding wordline of the respective die into which the data group is stored.

Because a duration of time associated with storing (e.g., programming) the upper logical page may be greater than an amount of time to store a wordline in the first die D0 operating in the single-bit mode, the ninth data group LG8 and the tenth data group LG9 may be provided to the first die D0 while the dies D1-D3 are each programming a corresponding lower logical page of data (of the data groups LG5-LG7). Accordingly, by programming the first die D0 using the single-bit mode and programming the dies D1-D3 using the multi bit mode, the first die D0 is able to store four wordlines worth of data for one wordline (e.g., an upper logical page and a lower logical page) worth of data stored at each of the dies D1-D3. Additionally, a total of ten data groups worth of data may be programmed into the dies D0-D1 during a time period associated with programming a single wordline into a particular die using the multi-bit mode. For example, if both the first die D0 and the second die D1 were programmed using the multi-bit mode, two data groups would be programmed into a first wordline of the first die D0 and two data groups would be programmed into a second wordline of the second die D1. Therefore, the mixed mode programming scheme illustrated in FIG. 3 enables a data storage rate that is greater than if the dies D0-D1 all used the multi-bit mode and were programmed concurrently.

To illustrate benefits of using a mixed mode programming scheme, the following examples are provided. In a first illustrative example, a first data storage device may include a non-volatile memory operating in the multi-bit mode and having a total of four dies that each have two planes and an individual storage capacity (X). Accordingly, the first data storage device has a total storage capacity of 4X. The non-volatile memory may be configured to concurrently program four dies, such as four representative dies D0-D3, using the multi-bit mode. To program the dies D0-D3, data may be striped across the dies to program a lower logical page followed by an upper logical page into each of the dies D0-D3 (e.g., a wordline having 256 kilobytes (kB) of data). If it takes 400 microseconds (μs) to program a lower logical page and 2.1 milliseconds (ms) to program an upper logical page, a total amount of time to program a wordline using the multi-bit mode may take 2.5 ms. Additionally, if the wordline programmed using the multi-bit mode may store a total amount of data (2-plane case) of 256 kB, a performance (e.g., a data storage rate) achieved may be equal to approximately 102 megabytes per second (MBps) (e.g., 256 KB divided by 2.5 ms).

In a second illustrative example, a second data storage device may include a non-volatile memory operating in the single-bit mode having a total of eight dies that each have two planes and an individual storage capacity (½ X). Accordingly, the second data storage device has a total storage capacity of 4X. The non-volatile memory may be configured to concurrently program four dies, such as four representative dies D0-D3, using the single-bit mode. To program the dies D0-D3, data may be striped across the dies to program a wordline (e.g., 128 KB of data) into each of the dies D0-D3. Additionally, if it takes 400 microseconds (μs) to program a particular wordline, a performance (e.g., a data storage rate) achieved may be equal to approximately 320 (MBps) (e.g., 128 KB divided by 2.5 ms). While the performance of the second data storage is over three times greater than the first data storage device, the second data storage device has twice as many dies as the first data storage device (e.g., the second data storage device has a 100% memory cost overhead as compared to the first data storage device.

In a third illustrative example, a third data storage device may include a non-volatile memory operating in the mixed mode programming scheme having a total of five dies that each have two planes. The non-volatile memory may be configured to concurrently program four dies, such as four representative dies D0-D3, wherein one die is programmed using the single-bit mode and three dies are programmed using the multi-bit mode (e.g., two bits per storage element). The fifth die may add additional capacity to the data storage device associated with a single-bit mode. Accordingly, the five dies may include two dies operating in the single-bit mode and having individual storage capacities (½ X). Additionally, the five dies may include three dies operating in the multi-bit mode and having individual storage capacities (X). Accordingly, the data storage device has a total storage capacity of 4X (e.g., two times ½X plus three times X). To program the dies D0-D3, data may be provided to be programmed into the representative dies D0-D2 in the order depicted at 350 of FIG. 3. As illustrated at 350 of FIG. 3, if it takes 400 microseconds (μs) to program a lower logical page and 2.1 milliseconds (ms) to program an upper logical page, a total amount of time to program a wordline using the multi-bit mode may take 2.5 ms. During the amount of time to program a particular wordline using the multi-bit mode, the four representative dies may be programmed to store a total of three wordlines (e.g., lower logical pages and upper logical pages) programmed according to the multi-bit mode (e.g., a total of 768 kB) and four wordlines programmed according to the single-bit mode (e.g., a total of 512 kB). An average amount of data programmed per die (2-plane case) during the 2.5 ms may be 320 kB (e.g., (768 kB+512 kB)/4 dies). Accordingly, a performance (e.g., a data storage rate) achieved by the third data storage device may be equal to approximately 131 megabytes per second (MBps) (e.g., 320 KB divided by 2.5 ms). The performance of the third data storage device having 5 dies is greater than the first data storage device having four dies operating in the multi-bit mode (e.g., there is a 25% memory cost overhead of the third data storage device over the first data storage device). The performance of the second data storage device having eight dies operating in the single-bit mode is greater than the third data storage device, but has an increased memory cost overhead as compared to the third data storage device.

In a fourth illustrative example, a fourth data storage device may include a non-volatile memory operating using the mixed mode programming scheme and having a total of four dies that each have two planes. The non-volatile memory may be configured to concurrently program four dies, such as four representative dies D0-D3, wherein one die is programmed using the single-bit mode and three dies are programmed using the multi-bit mode (e.g., two bits per storage element). Accordingly, the four dies may include one die operating in the single-bit mode and having individual storage capacity (½ X) and three dies operating in the multi-bit mode and having individual storage capacities (X). A total storage capacity of the fourth data storage device may be ((3.5)X) (e.g., ½X plus three times X). The representative dies D0-D3, may be programmed as described with reference to the third data storage device described above. Accordingly, a performance (e.g., a data storage rate) achieved by the fourth data storage device may be equal to approximately 131 megabytes per second (MBps) (e.g., 320 KB divided by 2.5 ms). The performance of the fourth data storage device having 4 dies may be greater than the first data storage device having four dies operating in the multi-bit mode. However, as compared to the first data storage element, there is no memory cost overhead when the first data storage device and the fourth data storage device are compared.

Based on the four illustrative data storage devices described above, it can be appreciated that a data storage device using the mixed mode programming scheme may provide a variety of data storage rates and memory costs. Data storage devices using the mixed mode programming scheme may be able to achieve a higher data storage rate with fewer dies than other data storage devices that use a single programming mode.

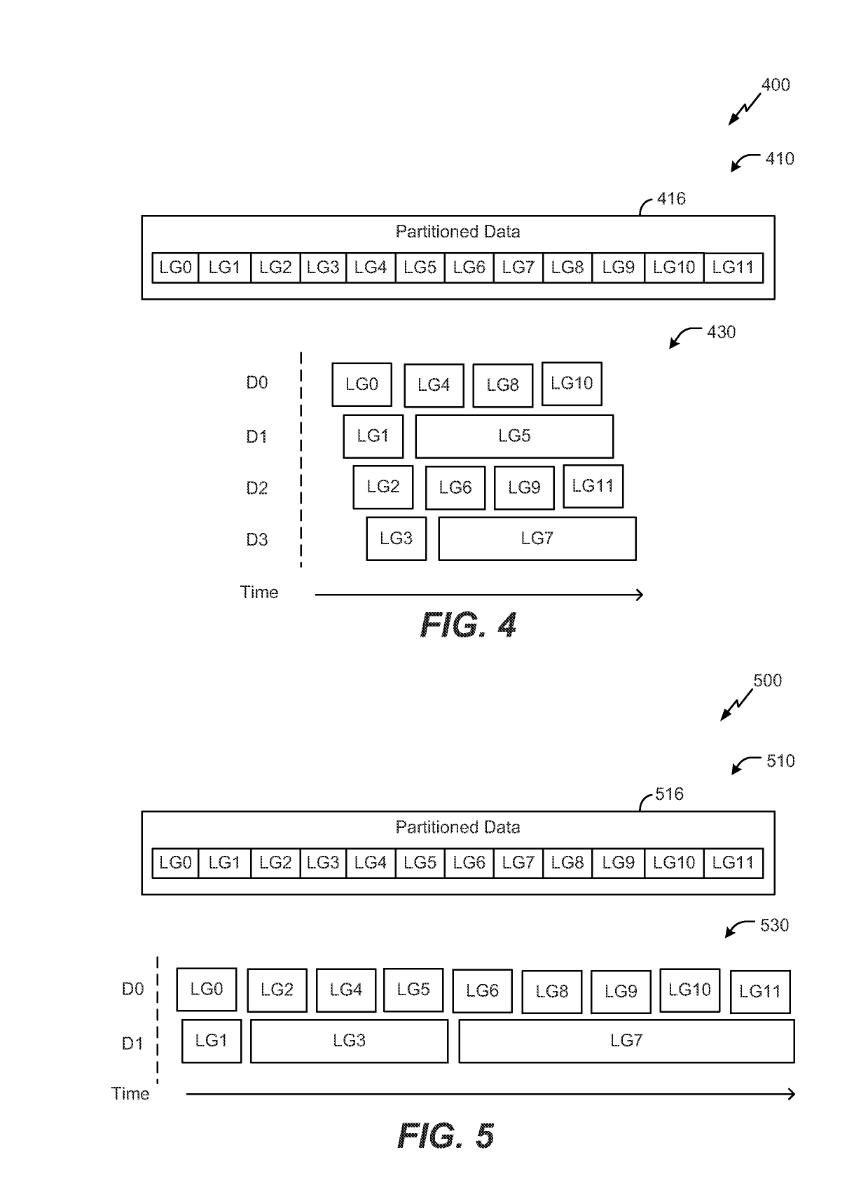

FIG. 4 is a diagram illustrating an example of using a mixed mode programming scheme to store data into a non-volatile memory of a data storage device. The mixed mode programming scheme may include a single-bit mode associated with storing one bit per storage element and a multi-bit mode associated with storing two bits per storage element. For example, the data may be stored into a non-volatile memory of the data storage device, such as the non-volatile memory 104 of the data storage device 102 of FIGS. 1-2. The non-volatile memory may be configured to concurrently program four dies, such as four representative dies D0-D3.

The data to be stored into the non-volatile memory may be partitioned to generate partitioned data 416, as illustrated at 410. The data may be partitioned in accordance with a die access scheme, such as the die access scheme 272 of FIG. 2. For example, the data may be partitioned into multiple data groups LG0-LG11 based on the group of dies to store the data, such as based on a number of dies using the single-bit mode and a number of dies using the multi-bit mode. For example, the multiple logical groups LG0-LG11 (e.g., a plurality of logical groups) may include a first data group LG0, a second data group LG1, a third data group LG2, a fourth data group LG3, a fifth data group LG4, a sixth data group LG5, a seventh data group LG6, an eighth data group LG7, a ninth data group LG8, a tenth data group LG9, an eleventh data group LG10, and a twelfth data group LG11. The multiple groups LG0-LG11 may be arranged based on an order in which the multiple groups are to be provided to and/or stored in the non-volatile memory based on the die access scheme.

An illustrative, non-limiting example of an order in which the multiple data groups LG0-LG11 may be provided to and programmed into dies D0-D3 is depicted at 430. The dies D0-D3 may include a first die D0 using the single-bit mode, a second die D1 using the multi-bit mode, a third die D2 using the single-bit mode, and a fourth die D3 using the multi-bit mode.

To program the partitioned data 416 into the dies D0-D3, the data groups LG0-LG3 may be provided to the dies D0-D3. Based on the first data group LG0 and the third data group LG2, each of the first die D0 and the third die D2 may store one wordline worth of data. Based on the second data group LG1, the second die D1 may store the second data group LG1 at a first logical page, such as an upper logical page, of a wordline of the second die D1. Further, based on the fourth data group LG3, the fourth die D3 may store the fourth data group LG3 at a first logical page, such as an upper logical page, of a wordline of the fourth die D3.

After the data groups LG0-LG2 are provided, the data groups LG4-LG7 may be provided to the dies D0-D3. Based on the fifth data group LG4 and the seventh data group LG6, each of the first die D0 and the third die D2 may store another wordline worth of data. Based on the sixth data group, the second die D1 may store the sixth data group at a second logical page, such as a lower logical page, of the wordline of the second die D1. Further, based on the eighth data group LG7, the fourth die D3 may store the eighth data group LG7 at a second logical page, such as a lower logical page, of the wordline of the fourth die D3.

Because a duration of time associated with storing (e.g., programming) the upper logical page may be greater than an amount of time to store a wordline in the first die D0 and a wordline in the third die D2, the data groups LG8-LG11 may be provided to the first die D0 and the third die D2 while programming of the lower logical pages of the second die D1 and the fourth die D3 is completed.

Accordingly, by programming the first die D0 and the third die D2 using the single-bit mode and programming the second die D1 and the fourth die D3 using the multi bit mode, the first die D0 and the third die D2 may each store four wordlines worth of data for one wordline (e.g., an upper logical page and a lower logical page) worth of data stored at the second die D1 and/or for one wordline worth of data stored at the fourth die D3. Additionally, a total of twelve data groups worth of data may be programmed into the dies D0-D1 during a time period associated with programming a single wordline into a particular die using the multi-bit mode.

FIG. 5 is a diagram illustrating an example of using a mixed mode programming scheme to store data into a non-volatile memory of a data storage device. The mixed mode programming scheme may include a single-bit mode associated with storing one bit per storage element and a multi-bit mode associated with storing three bits per storage element. For example, the data may be stored into a non-volatile memory of the data storage device, such as non-volatile memory 104 of the data storage device 102 of FIGS. 1-2.

The data to be stored into the non-volatile memory may be partitioned to generate partitioned data 516, as illustrated at 510. The data may be partitioned in accordance with a die access scheme, such as the die access scheme 272 of FIG. 2. For example, the data may be partitioned into multiple data groups LG0-LG11 based on the group of dies to store the data, such as based on a number of dies using the single-bit mode and a number of dies using the multi-bit mode. For example, the multiple logical groups LG0-LG11 (e.g., a plurality of logical groups) may include a first data group LG0, a second data group LG1, a third data group LG2, a fourth data group LG3, a fifth data group LG4, a sixth data group LG5, a seventh data group LG6, an eighth data group LG7, a ninth data group LG8, a tenth data group LG9, an eleventh data group LG10, and a twelfth data group LG11. The multiple groups LG0-LG11 may be arranged based on an order in which the multiple groups are to be provided to and/or stored in the non-volatile memory based on the die access scheme.

An illustrative, non-limiting example of an order in which the multiple data groups LG0-LG11 may be provided to and programmed into dies D0-D1 is depicted at 530. The dies D0-D1 may include a first die D0 using the single-bit mode and a second die D1 using the multi-bit mode (e.g., storing three bits per storage element). It is noted that a wordline programmed according to the multi-bit mode storing three bits per storage element is associated with three logical pages, an upper logical page which may correspond to one or more most significant bits (MSBs), a middle logical page, and a lower logical page which may correspond to one or more least significant bits (LSBs).

To program the partitioned data 516 into the dies D0-D1, the data groups LG0-LG1 may be provided to the dies D0-D1. The first data group LG0 may be programmed into a wordline of the first die D0 and the second data group LG1 may be programmed into a first logical page, such as an upper logical page, of a particular wordline of the second die D1. The second data group LG1 may be programmed into the second die D1 using the multi-bit mode. A duration of storing the first data group into the first die D0 using the single-bit mode may be comparable to a duration of time to store the first logical page into the second die D1 using the multi-bit mode.

The third data group LG2 may be provided to the first die D0 after the second data group LG1 is provided to the second die D1. The third data group LG2 may be stored in a second wordline of the first die D0. The fourth data group LG3 may be provided to the second die D1 and stored in a second logical page, such as a middle logical page, of the particular wordline of the second die D1. The fourth data group LG3 may be programmed into the second die D1 using the multi-bit mode. A duration of time associated with storing (e.g., programming) the middle logical page may be greater than an amount of time to store a wordline in the first die D0 operating in the single-bit mode. For example, a plurality of data groups, such as the fifth data group LG4 and the sixth data group LG5, may be able to be stored at the first die D0 while the fourth data group LG3 is written into the middle logical page of the second die D1.

The seventh data group LG6 may be provided to the first die D0 and the eighth data group LG7 may be provided to the second die D1 after the sixth data group LG5 is provided to the first die D0. The seventh data group LG6 may be stored in a wordline of the first die D0 using a single-bit mode. The eighth data group LG7 may be provided to the second die D1 and stored in a third logical page, such as a lower logical page, of the particular wordline of the second die D1. The eighth data group LG7 may be programmed into the second die D1 using the multi-bit mode. A duration of time associated with storing (e.g., programming) the lower logical page may be greater than an amount of time to store a wordline in the first die D0 operating in the single-bit mode. For example, a plurality of data groups, such as the ninth data group LG8, the tenth data group LG9, the eleventh data group LG10, and the twelfth data group LG11, may be able to be stored at the first die D0 while the eighth data group LG7 is written into the lower logical page of the second die D1.

As illustrated at 530, the first die D0 using the single-bit mode may store nine wordlines worth of data while the second die D1 using the multi-bit mode may store a single wordline worth of data. When a block of the first die D0 operating according to the single-bit mode includes a same number of wordlines as a block of the second die D1 operating in the multi-bit mode (e.g., three bits per storage element), the block of the first die D0 may be filled at a rate that is nine times faster than a rate at which the block of the second die may be filled.

By programming the first die D0 using the single-bit mode and programming the second die D1 using the multi-bit mode (e.g., three bits per storage element), the dies D0, D1 may be programmed with twelve data groups during a time period that is associated with programming a single wordline into a die using the multi-bit mode, such as the second die D1. If both the first die D0 and the second die D1 were programmed using the multi-bit mode, six data groups would be programmed during the time period associated with programming a single wordline into a die using the multi-bit mode. For example, if both the first die D0 and the second die D1 were programmed using the multi-bit mode, three data groups would be programmed into a first wordline of the first die D0 and three data groups would be programmed into a second wordline of the second die D1. Therefore, to store twelve data groups into the first die D0 and the second die D1 that are operating in the multi-bit mode would take longer than a time period that is associated with programming a single wordline into a die using the multi-bit mode. Accordingly, a latency associated with storing data into a non-volatile memory (including the first die D0 and the second die D1) using the single-bit mode and the multi-bit mode is less than a latency associated with storing the data using only the multi-bit mode.

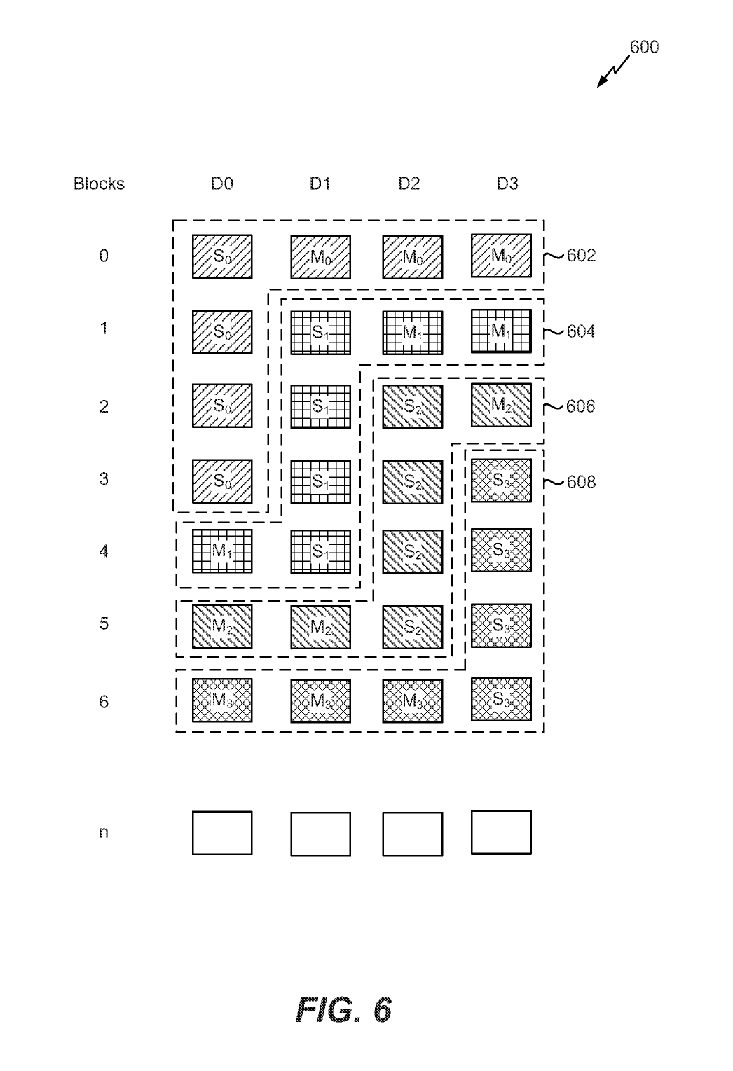

FIG. 6 is a diagram illustrating an example of storing data into a non-volatile memory according to a mixed mode programming scheme and is designated 600. The mixed mode programming scheme may include a single-bit mode associated with storing one bit per storage element and a multi-bit mode associated with storing two bits per storage element. With reference to FIG. 6, the multi-bit mode may be associated with storing two-bits per storage element. The non-volatile memory may be included in a data storage device, such as the data storage device 102 of FIGS. 1-2. The non-volatile memory may include or correspond to the non-volatile memory 104 of FIGS. 1-2 or the non-volatile memory 312 of FIG. 3.

The non-volatile memory may include a plurality of dies D0-D3. For example, the plurality of dies D0-D1 may include a first die D0, a second die D1, a third die D2, and a fourth die D3. Each die of the plurality of dies D0-D3 may include multiple blocks, such as blocks 0-n (e.g., wherein n is a positive integer). Although each of the dies D0-D3 is illustrated as having a same number of blocks, one or more of the dies D0-D3 may have a different number of blocks.

The non-volatile memory may be configured to concurrently program multiple dies concurrently, such as four dies. To program data into the four dies concurrently using the mixed mode programming scheme, each of the four dies is determined to operate in one of the single-bit mode or the multi-bit mode and a number of blocks that may be used for each die is identified. A number of dies to be programmed according to the single-bit mode and a number of dies to be programmed according to the multi-bit mode may be determined based on a die access scheme, such as the die access scheme 272 of FIG. 2. For example, the die access scheme may dictate that a single die of the four dies uses the single-bit mode and that three dies of the four dies use the multi-bit mode. A particular die, of the four dies, may be determined to operate in the single-bit mode based on a rotation scheme, such as the rotation scheme 270 of FIG. 2. For each die, a corresponding number of blocks may be determined based on the die access scheme. When a single die uses the single-bit mode and three dies use the multi-bit mode (e.g., storing two bits per storage element), the die access scheme may indicate that four blocks of the single die using the single-bit mode are available for data storage and may indicate that one block of each of the three dies using the multi-bit mode are available for data storage. The rotation scheme and the die access scheme may be implemented by a controller of the data storage device, such as the controller 120 of FIG. 1.

To illustrate, to store first data, the first die D0 may be determined to use the single-bit mode and the second die D1, the third die D2, and the fourth die D3 may be determined to be used in the multi-bit mode. Additionally, a first group of blocks 602 may be identified to store the first data. The first group of blocks 602 may include blocks 0-3 of the first die D0 and block 0 of each of the dies D1-D3.

To store second data, the second die D1 may be determined to use the single-bit mode and the first die D0, the third die D2, and the fourth die D3 may be determined to be used in the multi-bit mode. Additionally, a second group of blocks 604 may be identified to store the second data. The second group of blocks 604 may include block 4 of the first die D0, blocks 1-4 of the second die D2, and block 1 of each of the dies D2-D3.

To store third data, the third die D2 may be determined to use the single-bit mode and the first die D0, the second die D1, and the fourth die D3 may be determined to be used in the multi-bit mode. Additionally, a third group of blocks 606 may be identified to store the third data. The third group of blocks 606 may include block 5 of the dies D0-D1, blocks 2-5 of the third die D3, and block 2 of the fourth die D3.

To store fourth data, the fourth die D3 may be determined to use the single-bit mode and the dies D0-D2 may be determined to be used in the multi-bit mode. Additionally, a fourth group of blocks 608 may be identified to store the fourth data. The fourth group of blocks 608 may include block 6 of the dies D0-D2 and blocks 3-6 of the fourth die D3.

By changing which die of the plurality of dies D0-D3 is used in the single-bit mode, data may be stored into all of the blocks of the plurality of dies D0-D3 and wear may be distributed and managed among storage elements of the non-volatile memory. By distributing and managing wear of the non-volatile memory, endurance (e.g., an operating life-time) of the data storage device may be increased.

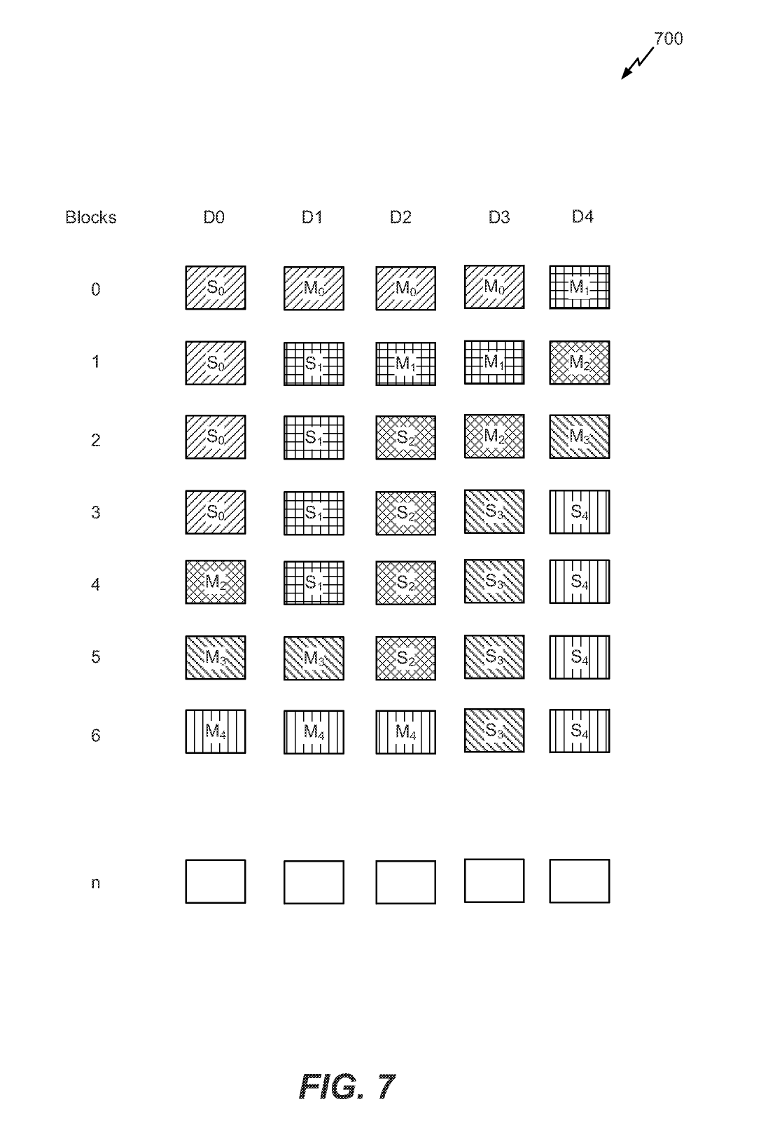

FIG. 7 is a diagram illustrating an example of storing data into a non-volatile memory according to a mixed mode programming scheme and is designated 700. The mixed mode programming scheme may include a single-bit mode associated with storing one bit per storage element and a multi-bit mode associated with storing two bits per storage element. With reference to FIG. 7, the multi-bit mode may be associated with storing two-bits per storage element. The non-volatile memory may be included in a data storage device, such as the data storage device 102 of FIGS. 1-2. The non-volatile memory may include or correspond to the non-volatile memory 104 of FIGS. 1-2 or the non-volatile memory 312 of FIG. 3.

The non-volatile memory may include a plurality of dies D0-D4. For example, the plurality of dies D0-D1 may include a first die D0, a second die D1, a third die D2, a fourth die D3, and a fifth die D4. Each die of the plurality of the dies D0-D4 may include multiple blocks, such as blocks 0-n (e.g., wherein n is a positive integer). Although each of the dies D0-D4 is illustrated as having a same number of blocks, one or more of the dies D0-D4 may have a different number of blocks.

The non-volatile memory may be configured to concurrently program multiple dies, such as four dies. To program data into the four dies concurrently using the mixed mode programming scheme, multiple groups of four dies of the plurality of dies D0-D4 may be identified. For each group of four dies, each die of each group may be determined to operate in one of the single-bit mode or the multi-bit mode and a number of blocks that may be used for each die may be identified. A number of dies for each group to be programmed according to the single-bit mode and a number of dies to be programmed according to the multi-bit mode may be determined based on a die access scheme, such as the die access scheme 272 of FIG. 2. For example, the die access scheme may dictate that a single die of each group of four dies uses the single-bit mode and that three dies of each group of four dies use the multi-bit mode. For each group of four dies, a particular die may be determined to operate in the single-bit mode based on a rotation scheme, such as the rotation scheme 270 of FIG. 2. For each die of each group of four dies, a corresponding number of blocks may be determined based on the die access scheme. When a single die uses the single-bit mode and three dies use the multi-bit mode (e.g., storing two bits per storage element), the die access scheme may indicate that four blocks of the single die using the single-bit mode are available for data storage and may indicate that one block of each of the three dies using the multi-bit mode are available for data storage. The rotation scheme and the die access scheme may be implemented by a controller of the data storage device, such as the controller 120 of FIG. 1.

To illustrate, a first group of dies may be identified to store first data. The first group may include dies D0-D3. In the first group, the first die D0 may be determined to use the single-bit mode and dies D1-D3 may be determined to be used in the multi-bit mode. A second group of dies may be identified to store second data. The second group may include dies D1-D4. In the second group, the second die D1 may be determined to use the single-bit mode and dies D2-D4 may be determined to be used in the multi-bit mode. A third group of dies may be identified to store third data. The third group may include dies D0, D2-D4. In the third group, the third die D2 may be determined to use the single-bit mode and dies D0, D3, D4 may be determined to be used in the multi-bit mode.

A fourth group of dies may be identified to store fourth data. The fourth group may include dies D0-D1, D3-D4. In the fourth group, the fourth die D3 may be determined to use the single-bit mode and dies D0-D1, D4 may be determined to be used in the multi-bit mode. A fifth group of dies may be identified to store fifth data. The fifth group may include dies D0-D2, D4. In the fifth group, the fifth die D4 may be determined to use the single-bit mode and dies D0-D2 may be determined to be used in the multi-bit mode.

By using the rotation scheme, a data storage device may rotate which die(s) of the plurality of dies D0-D4 are programmed according to the single-bit mode to account for uneven wear among the plurality of dies. By accounting for uneven wear, the rotation scheme may be used to promote endurance (e.g., an operating life-time) of the data storage device.

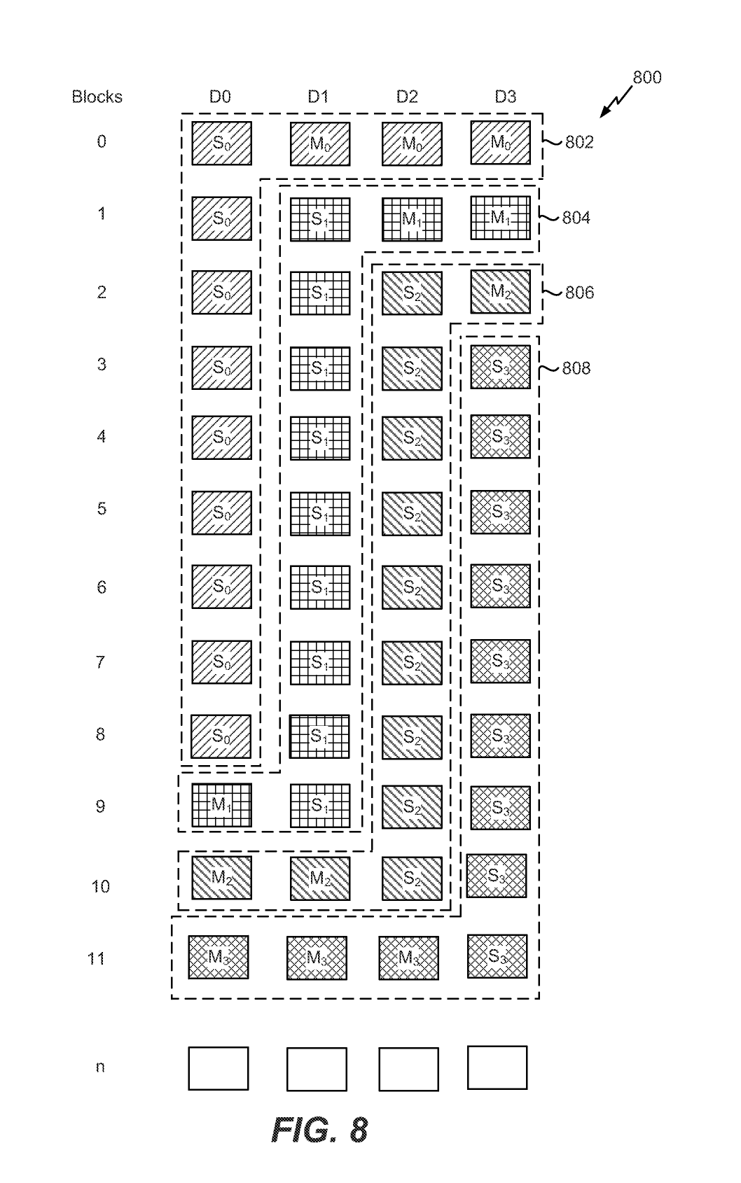

FIG. 8 is a diagram illustrating an example of storing data into a non-volatile memory according to a mixed mode programming scheme and is designated 800. The mixed mode programming scheme may include a single-bit mode associated with storing one bit per storage element and a multi-bit mode. With reference to FIG. 8, the multi-bit mode may be associated with storing three-bits per storage element. The non-volatile memory may be included in a data storage device, such as the data storage device 102 of FIGS. 1-2. The non-volatile memory may include or correspond to the non-volatile memory 104 of FIGS. 1-2 or the non-volatile memory 312 of FIG. 3.

The non-volatile memory may include a plurality of dies D0-D3. For example, the plurality of dies D0-D1 may include a first die D0, a second die D1, a third die D2, and a fourth die D3. Each die of the plurality of dies D0-D3 may include multiple blocks, such as blocks 0-n (e.g., wherein n is a positive integer). Although each of the dies D0-D3 is illustrated as having a same number of blocks, one or more of the dies D0-D3 may have a different number of blocks.

The non-volatile memory may be configured to concurrently program multiple dies, such as four dies. To program data into the four dies concurrently using the mixed mode programming scheme, each of the four dies is determined to operate in one of the single-bit mode or the multi-bit mode and a number of blocks that may be used for each die is identified. A number of dies to be programmed according to the single-bit mode and a number of dies to be programmed according to the multi-bit mode may be determined based on a die access scheme, such as the die access scheme 272 of FIG. 2. For example, the die access scheme may dictate that a single die of the four dies uses the single-bit mode and that three dies of the four dies use the multi-bit mode. A particular die, of the four dies, may be determined to operate in the single-bit mode based on a rotation scheme, such as the rotation scheme 270 of FIG. 2. For each die, a corresponding number of blocks may be allocated based on a mode of the die. For example, the die access scheme may indicate that nine blocks of the die using the single-bit mode are available for data storage and may indicate that one block of each die using the multi-bit mode is available for data storage. The rotation scheme and the die access scheme may be implemented by a controller of the data storage device, such as the controller 120 of FIG. 1.

To illustrate, to store first data, the first die D0 may be determined to use the single-bit mode and the dies D1-D3 may be determined to be used in the multi-bit mode. Additionally, a first group of blocks 602 may be identified to store the first data. To store second data, the second die D1 may be determined to use the single-bit mode and the dies D0, D2-D3 may be determined to be used in the multi-bit mode. Additionally, a second group of blocks 604 may be identified to store the second data.

To store third data, the third die D2 may be determined to use the single-bit mode and the dies D0-D1, D3 may be determined to be used in the multi-bit mode. Additionally, a third group of blocks 606 may be identified to store the third data. To store fourth data, the fourth die D3 may be determined to use the single-bit mode and the dies D0-D2 may be determined to be used in the multi-bit mode. Additionally, a fourth group of blocks 608 may be identified to store the fourth data.

By changing which die of the plurality of dies D0-D3 is used in the single-bit mode, data may be stored into all of the blocks of the plurality of dies D0-D3 and wear may be distributed and managed among the non-volatile memory. By distributing and managing wear of the non-volatile memory, endurance (e.g., an operating life-time) of the data storage device may be increased.

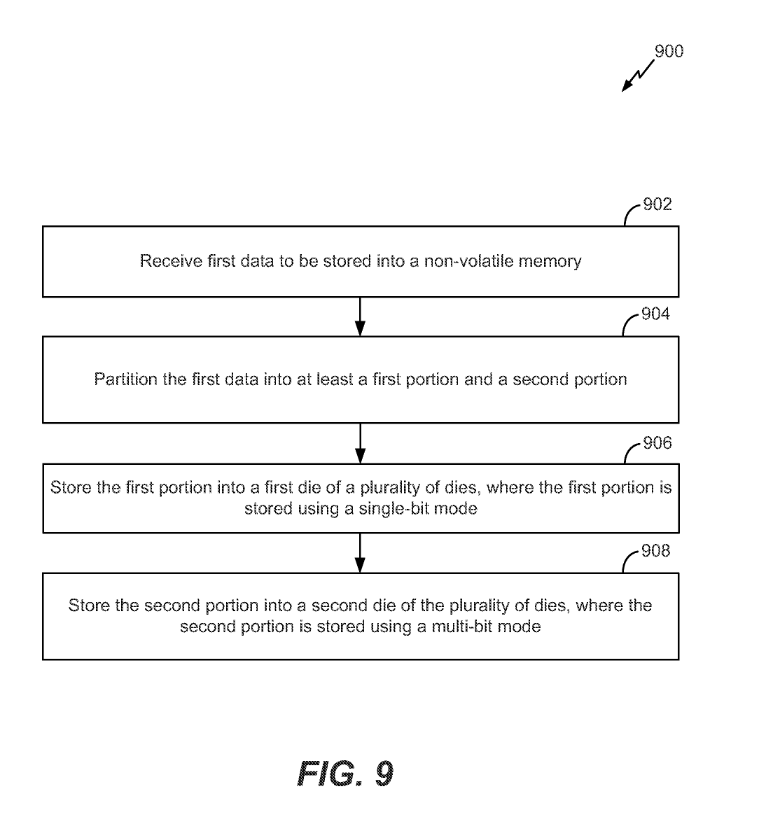

FIG. 9 illustrates a particular embodiment of a method 900 that may be performed at a data storage device, such as the data storage device 102 of FIG. 1. For example, the method 900 may be performed by the controller 120 and/or the storage engine 154 of FIG. 1.

The method 900 includes receiving first data to be stored into a non-volatile memory, at 902. The first data may be received by a controller, such as the controller 120, of the data storage device. The first data may be received from a host device, such as the user data 106 received from the host device 130. The non-volatile memory may include a plurality of dies. For example, the non-volatile memory may include or correspond to the non-volatile memory 104 of FIG. 1.

The method 900 also includes partitioning the first data into at least a first portion and a second portion, at 904. The controller may partition the first data to generate partitioned data including the first portion and the second portion. The partitioned data may include or correspond to the partitioned data 112 including the first portion 108 and the second portion 118 of FIG. 1, the first partitioned data 208 and the second partitioned data 218 of FIG. 2, the partitioned data 336 of FIG. 3, the partitioned data 416 of FIG. 4, or the partitioned data 510 of FIG. 5.

The method 900 further includes storing the first portion into a first die of the plurality of dies, where the first portion is stored using a single-bit mode, at 906. For example, the first portion 108 may be stored into the first die 132 of FIG. 1. The first portion may be stored into the first die using write circuitry, such as the single-bit write circuitry 122 of FIG. 1 or the read/write circuitry 226 of FIG. 2.

The method 900 further includes storing the second portion into a second die of the plurality of dies, where the second portion is stored using a multi-bit mode, at 908. For example, the first portion 118 may be stored into the second die 142 of FIG. 2. The second portion may be stored into the second die using the write circuitry, such as the multi-bit write circuitry 124 of FIG. 1 or the read/write circuitry 226 of FIG. 2.

By storing the first portion according to the single-bit mode and by storing the second portion according to the multi-bit mode, the data storage device may achieve a target performance (e.g., a data storage rate).

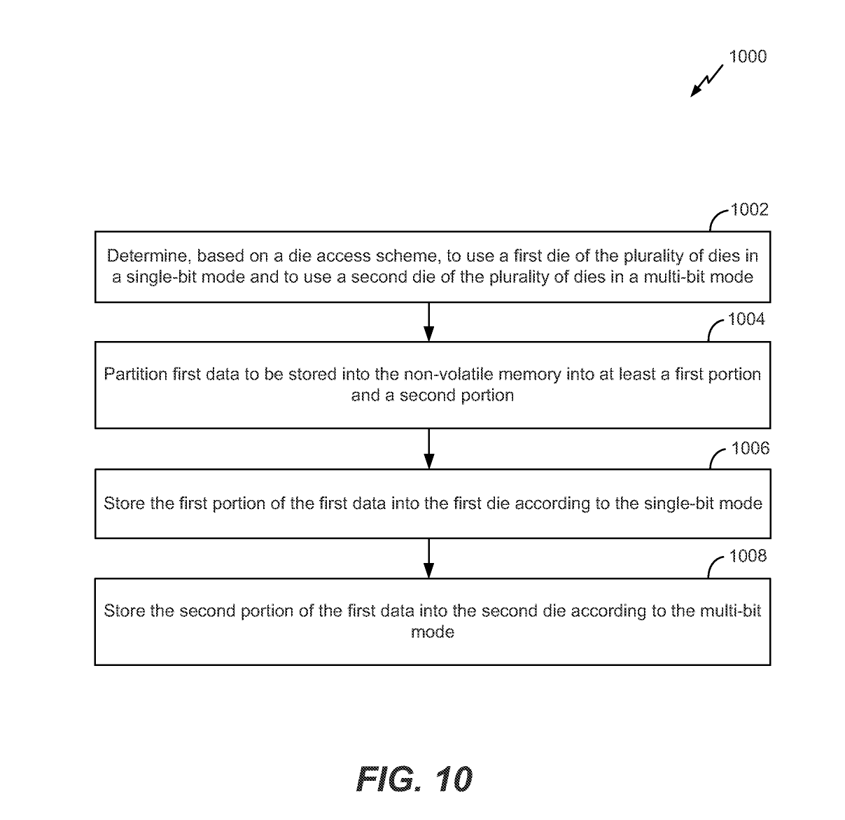

FIG. 10 illustrates a particular embodiment of a method 1000 that may be performed at a data storage device, such as the data storage device 102 of FIG. 1. For example, the method 1000 may be performed by the controller 120 and/or the storage engine 154 of FIG. 1.

The method 1000 includes determining, based on a die access scheme, to use a first die of a plurality of dies in a single-bit mode and to use a second die of the plurality of dies in a multi-bit mode, at 1002. The plurality of dies may be included in a non-volatile memory, such as the non-volatile memory 104 of FIG. 1.

The method 1000 also includes partitioning first data to be stored into the non-volatile memory into at least a first portion and a second portion, at 1004. The controller may partition the first data to generate partitioned data including the first portion and the second portion. The partitioned data may include or correspond to the partitioned data 112 including the first portion 108 and the second portion 118 of FIG. 1, the first partitioned data 208 and the second partitioned data 218 of FIG. 2, the partitioned data 336 of FIG. 3, the partitioned data 416 of FIG. 4, or the partitioned data 510 of FIG. 5.

The method 1000 further includes storing the first portion of the first data into the first die according to the single-bit mode, at 1006. For example, the first portion 108 may be stored into the first die 132 of FIG. 1. The first portion may be stored into the first die using write circuitry, such as the write circuitry 156 of FIG. 1 or the read/write circuitry 226 of FIG. 2.

The method 1000 further includes storing the second portion of the first data into the second die according to the multi-bit mode, at 1008. For example, the first portion 118 may be stored into the second die 142 of FIG. 2. The second portion may be stored into the second die using the write circuitry, such as the write circuitry 156 of FIG. 1 or the read/write circuitry 226 of FIG. 2.

By storing the first portion according to the single-bit mode and by storing the second portion according to the multi-bit mode, the data storage device may achieve a target performance (e.g., a data storage rate).

The method 900 of FIG. 9 and/or the method 1000 of FIG. 10 may be initiated or controlled by a field-programmable gate array (FPGA) device, an application-specific integrated circuit (ASIC), a processing unit, such as a central processing unit (CPU), a digital signal processor (DSP), a controller, another hardware device, a firmware device, or any combination thereof. As an example, the method 900 of FIG. 9 and/or the method 1000 of FIG. 10 can be initiated or controlled by one or more processors included in or coupled to the data storage device 102 of FIG. 1, such as one or more processors included in or coupled to the controller 120 of FIG. 1.

A controller configured to perform the method 900 of FIG. 9 and/or the method 1000 of FIG. 10, may be able to advantageously program a non-volatile memory of a data storage device using a mixed mode programming scheme. Although various components of the data storage device 102 depicted herein are illustrated as block components and described in general terms, such components may include one or more microprocessors, state machines, or other circuits configured to enable the controller 120 and/or the storage engine 154 of FIG. 1 to perform operations described herein. One or more aspects of the controller 120 and/or the storage engine 154 may be implemented using a microprocessor or microcontroller programmed to perform operations described herein, such as one or more operations of the method 900 of FIG. 9, the method 1000 of FIG. 10, or a combination thereof. In a particular embodiment, the controller 120 and/or the storage engine 154 includes a processor executing instructions that are stored at the non-volatile memory 104. Alternatively or additionally, executable instructions that are executed by the processor may be stored at a separate memory location that is not part of the non-volatile memory 104, such as at a read-only memory (ROM).

The controller 120 and/or the storage engine 154 of FIG. 1 may be implemented using a microprocessor or microcontroller programmed to perform the method 900 of FIG. 9 and/or the method 1000 of FIG. 10. For example, the microprocessor or microcontroller may be configured to execute instructions (e.g., a series of instructions, such as an algorithm) to perform certain operations described herein. In a particular embodiment, the controller 120 and/or the storage engine 154 (e.g., the microprocessor or microcontroller) includes a processor executing instructions that are stored at the non-volatile memory 104. Alternatively or alternatively, executable instructions that are executed by the processor may be stored at a separate memory location that is not part of the non-volatile memory 104, such as at a read-only memory (ROM).

In a first illustrative example, the processor may execute the instructions to receive first data to be stored into a non-volatile memory. The instructions to receive the first data may include instructions to identify a write instruction (e.g., the write instruction received from a host device) and/or instructions to identify data to be stored, as an illustrative, non-limiting example. The processor executes instructions to partition the first data into at least a first portion and second portion. The instructions to partition the first data may include instructions to divide the first data into a plurality of data groups and/or instructions to order the plurality of data groups, as an illustrative, non-limiting example. The processor may execute the instructions to store the first portion into a first die of a plurality of dies, where the first portion is stored using a single-bit mode. The instructions to store the first portion into the first die may include instructions to select a first data group of the plurality of data groups, instructions to generate a first write command associated with the first data group (e.g., the first write command associated with the single-bit mode), instructions to send the first write command to write circuitry, and/or instructions to execute the first write command, as an illustrative, non-limiting example. The processor may execute the instructions to store the second portion into a second die of the plurality of dies, where the second portion is stored using a multi-bit mode. The instructions to store the second portion into the second die may include instructions to select a second data group of the plurality of data groups, instructions to generate a second write command associated with the second data group (e.g., the second write command associated with the multi-bit mode), instructions to send the second write command to write circuitry, and/or instructions to execute the second write command, as an illustrative, non-limiting example. Although the first illustrative example is described as having a plurality of data groups that includes the first data group and the second data group, the plurality of data groups is not limited to two data groups and may include more than two data groups.

In a second illustrative example, the processor may execute the instructions to determine, based on a die access scheme, to use a first die of a plurality of dies in a single-bit mode and to use a second die of the plurality of dies in a multi-bit mode. The instructions to determine to use the first die and the second die may include instructions to identify a storage scheme, instructions to determine (e.g., select) a group of dies, instructions to determine a number of dies to be used in a single-bit mode, instructions to determine a number of dies to be used in a multi-bit mode, instructions to identify the first die to be used in the single-bit mode, and/or instructions to identify the second die to be used in the multi-bit mode, as an illustrative, non-limiting example. The processor executes the instructions to partition first data to be stored into a non-volatile memory into at least a first portion and a second portion. The instructions to partition the first data may include instructions to divide the first data into a plurality of data groups and/or instructions to order the plurality of data groups, as an illustrative, non-limiting example. The processor may execute the instructions to store the first portion of the first data into the first die according to the single-bit mode. The instructions to store the first portion into the first die may include instructions to select a first data group of the plurality of data groups, instructions to generate a first write command associated with the first data group (e.g., the first write command associated with the single-bit mode), instructions to send the first write command to write circuitry, and/or instructions to execute the first write command, as an illustrative, non-limiting example. The processor may execute the instructions to store the second portion of the first data into the second die according to the multi-bit mode. The instructions to store the second portion into the second die may include instructions to select a second data group of the plurality of data groups, instructions to generate a second write command associated with the second data group (e.g., the second write command associated with the multi-bit mode), instructions to send the second write command to write circuitry, and/or instructions to execute the second write command, as an illustrative, non-limiting example. Although the second illustrative example is described as having a plurality of data groups that includes the first data group and the second data group, the plurality of data groups is not limited to two data groups and may include more than two data groups.

In a particular embodiment, the data storage device 102 may be attached to, or embedded within, one or more host devices, such as within a housing of a portable communication device. For example, the data storage device 102 may be within a packaged apparatus such as a wireless telephone, a personal digital assistant (PDA), a gaming device or console, a portable navigation device, a computer device (e.g., a tablet or a laptop), or other device that uses internal non-volatile memory. However, in other embodiments, the data storage device 102 may be a portable device configured to be selectively coupled to one or more external devices. For example, the data storage device 102 may be a removable device such as a Universal Serial Bus (USB) flash drive or a removable memory card, as illustrative examples. In a particular embodiment, the non-volatile memory 130 includes a flash memory (e.g., NAND, NOR, Multi-Level Cell (MLC), Divided bit-line NOR (DINOR), AND, high capacitive coupling ratio (HiCR), asymmetrical contactless transistor (ACT), or other flash memories), an erasable programmable read-only memory (EPROM), an electrically-erasable programmable read-only memory (EEPROM), a read-only memory (ROM), a one-time programmable memory (OTP), or any other type of memory.

The illustrations of the embodiments described herein are intended to provide a general understanding of the various embodiments. The illustrations are not intended to serve as a complete description of all of the elements and features of apparatus and systems that utilize the structures or methods described herein. Other embodiments may be utilized and derived from the disclosure, such that structural and logical substitutions and changes may be made without departing from the scope of the disclosure. Although specific embodiments have been illustrated and described herein, it should be appreciated that any subsequent arrangement capable of achieving the same or similar purpose or functionality may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description. Accordingly, the disclosure and the figures are to be regarded as illustrative rather than restrictive.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of storing data, the method comprising:
in a data storage device including a controller and a non-volatile memory, wherein the non-volatile memory includes a plurality of dies, performing:
receiving first data to be stored into the non-volatile memory;
partitioning the first data into at least a first portion and a second portion;
storing the first portion into a first die of the plurality of dies, wherein the first portion is stored using a single-bit mode; and
storing the second portion into a second die of the plurality of dies, wherein the second portion is stored using a multi-bit mode.

2. The method of claim 1, wherein a latency associated with storing the data into the non-volatile memory using the single-bit mode and the multi-bit mode is less than a latency associated with storing the data using only the multi-bit mode.

3. The method of claim 1, wherein multiple wordlines of the first die are programmed while a single wordline of the second die is programmed.

4. The method of claim 1, further comprising partitioning the first data to generate multiple data groups, wherein the first portion includes a first number of data groups of the multiple data groups, and wherein the second portion includes a second number of data groups of the multiple data groups.

5. The method of claim 4, wherein the multiple data groups are stored at a binary cache of the data storage device prior to being stored to the plurality of dies.

6. The method of claim 4, further comprising storing a first data group of the multiple data groups into the first die, wherein the first data group is stored into a first wordline of the first die using the single-bit mode.

7. The method of claim 6, further comprising:
storing a second data group of the multiple data groups into the second die, wherein the second data group is associated with a first logical page of a second wordline of the second die and is stored at the second wordline using the multi-bit mode; and
storing a third data group of the multiple data groups into the second die, wherein the third data group is associated with a second logical page of the second wordline and is stored at the second wordline using the multi-bit mode.

8. The method of claim 1, further comprising tracking which blocks of the first die are programmed using the single-bit mode.

9. A method of storing data, the method comprising:
in a data storage device including a controller and a non-volatile memory, wherein the non-volatile memory includes a plurality of dies, performing:
determining, based on a die access scheme, to use a first die of the plurality of dies in a single-bit mode and to use a second die of the plurality of dies in a multi-bit mode;
partitioning first data to be stored into the non-volatile memory into at least a first portion and a second portion;
storing the first portion of the first data into the first die according to the single-bit mode; and
storing the second portion of the first data into the second die according to the multi-bit mode.

10. The method of claim 9, wherein the die access scheme is based on a data storage rate of the non-volatile memory.

11. The method of claim 9, further comprising, prior to determining to use the first die in the single-bit mode and to use the second die in the multi-bit mode, selecting a first group of dies of the plurality of dies to store the first data,

12. The method of claim 11, wherein the first group of dies is selected from the plurality of dies based on a rotation scheme.

13. The method of claim 11, further comprising:
receiving second data to be stored at the non-volatile memory; and
selecting a second group of dies of the plurality of dies to store the second data, wherein the second group of dies includes the first die and the second die; and
determining, based on the die access scheme, to use the first die in the multi-bit mode and to use the second die in the single-bit mode.

14. The method of claim 13, further comprising:
using first write circuitry to store the first portion of the first data into the first die when the first die is in the single-bit mode; and
using second write circuitry to store a particular portion of the second data into the first die when the first die is in the multi-bit mode, wherein the second write circuitry is distinct from the first write circuitry.

15. The method of claim 9, wherein, when the first die is determined to be programmed according to the single-bit mode, a first number of blocks of the first die are allocated to be programmed according to the single-bit mode.

16. The method of claim 15, wherein, when the second die is selected to be programmed according to the multi-bit mode, a second number of blocks of the second die are allocated to be programmed according to the multi-bit mode, and wherein the first number of blocks is greater than the second number of blocks.

17. A data storage device comprising:
a non-volatile memory including a plurality of dies, wherein the plurality of dies includes a first die and a second die; and
a controller coupled to the non-volatile memory, wherein the controller is configured to receive first data to be stored into the non-volatile memory and to partition the data into a first portion and a second portion, wherein the controller is further configured to store the first portion into the first die and to store the second portion into the second die, wherein the first portion is stored into the first die using a single-bit mode, and wherein the second portion is stored into the second die using a multi-bit mode.

18. The data storage device of claim 17, wherein, prior to storing the first data into the non-volatile memory, the controller is configured to select a first group of dies of the plurality of dies and to assign each die of the first group of dies to operate according to one of the single-bit mode or the multi-bit mode, and wherein each die operates in a corresponding assigned mode during storage of the first data into the non-volatile memory.

19. The data storage device of claim 18, wherein the first group of dies includes less than all of the plurality of dies included in the non-volatile memory.

20. The data storage device of claim 18, wherein the first group of dies is selected from the plurality of dies based on a rotation scheme, and wherein each die of the first group of dies is assigned to operate according to one of the single-bit mode or the multi-bit mode based on a die access scheme.

21. The data storage device of claim 18, wherein the first group of dies is selected to store the first data, wherein the controller is further configured to receive second data to be stored into the non-volatile memory and to select a second group of dies of the plurality of dies, and wherein the second group of dies is selected to store the second data.

22. The data storage device of claim 18, wherein each die of the first group of dies is assigned to operate using one of the single-bit mode or the multi-bit mode, wherein each die of the first group of dies is assigned based on a die access scheme.

23. The data storage device of claim 22, wherein the die access scheme identifies a first number of dies of the first group of dies to operate according to the single-bit mode, a second number of dies of the first group of dies to operate according to the multi-bit mode, or a combination thereof.

24. The data storage device of claim 17, wherein the first portion stored into the first die using the single-bit mode is stored into the first die as a single-bit per storage element of the first die, and wherein the second portion stored into the second die using the multi-bit mode is stored into the second die as multiple bits per storage element of the second die.

25. The data storage device of claim 17, wherein the non-volatile memory includes first write circuitry and second write circuitry, wherein the first write circuitry is configured to operate in accordance with the single-bit mode, and wherein the second write circuitry is configured to operate in accordance with the multi-bit mode.

26. The data storage device of claim 17, wherein the non-volatile memory comprises a flash memory.
